(19) United States
(12) Patent Application Publication
(10) Pub. No.: US 2022/0382091 A1
(43) Pub. Date: Dec. 1, 2022

(54) OPTICAL COMPENSATION ELEMENT, LIQUID-CRYSTAL DISPLAY DEVICE, AND ELECTRONIC APPARATUS

(71) Applicant: SONY GROUP CORPORATION, TOKYO (JP)

(72) Inventor: SHINTARO NAKANO, TOKYO (JP)

(21) Appl. No.: 17/763,104

(22) PCT Filed: Jul. 7, 2020
(86) PCT No.: PCT/JP2020/027984

§ 371 Date: Mar. 23, 2022

(30) Foreign Application Priority Data
Oct. 1, 2019 (JP) 2019-181391

(51) Int. Cl. G02F 1/13363

(52) U.S. Cl. CPC G02F 1/13363

(57) ABSTRACT

A liquid-crystal display device includes a pair of substrates, a liquid-crystal material layer sandwiched between the pair of substrates, and an optical compensation element having an optical compensation layer, the optical compensation layer including a stack group in which high-refractive-index obliquely deposited films and low-refractive-index obliquely deposited films are alternately deposited, the high-refractive-index obliquely deposited films and the low-refractive-index obliquely deposited films having a same tilt direction with respect to a normal line of a surface on which the films are deposited.

### TECHNICAL FIELD

The present disclosure relates to an optical compensation element, a liquid-crystal display device, and an electronic apparatus.

### BACKGROUND ART

A liquid-crystal display device having a configuration in which a liquid-crystal material layer is sandwiched between a pair of substrates is known. The liquid-crystal display device displays an image by operating pixels as optical shutters (light bulbs). In recent years, achieving high-luminance and high-contrast as well as high-definition in the liquid-crystal display device is demanded.

Using an optical compensation element having an optical compensation layer that compensates for a refractive-index anisotropy due to a liquid-crystal material layer is known as means for achieving high-contrast. In a case of a liquid-crystal display device in which liquid-crystal molecules are aligned approximately perpendicular to a substrate surface, an optical compensation element that constitutes an O-plate for compensating for influences of tilted components due to the tilt angle of the liquid-crystal molecules and an optical compensation element that constitutes a C-plate for compensating for refractive-index anisotropy of the liquid-crystal material layer are typically used (e.g., see Patent Literature 1). The C-plate is typically formed in a surface of a transistor array substrate or an opposite substrate, which is located on the side of the liquid-crystal material layer. In contrast, the O-plate is often disposed as another member outside the substrate.

### CITATION LIST

### Patent Literature

Patent Literature 1: Japanese Patent Application Laid-open No. 2011-76030

### DISCLOSURE OF INVENTION

### Technical Problem

In view of improving the optical compensation effect, it is favorable to provide a configuration in which an optical compensation element is basically formed in a substrate that constitutes the liquid-crystal display device. Moreover, in view of reducing the manufacturing processes and the number of components of the liquid-crystal display device, it is favorable to reduce types of optical compensation elements to be used in the liquid-crystal display device.

Therefore, it is an object of the present disclosure to provide an optical compensation element that is capable of reducing types of optical compensation elements to be used in the liquid-crystal display device and is favorable for being formed in a substrate to be used in the liquid-crystal display device, a liquid-crystal display device including such an optical compensation element, and an electronic apparatus including such a liquid-crystal display device.

### Solution to Problem

An optical compensation element according to the present disclosure for accomplishing the above-mentioned object is an optical compensation element including

an optical compensation layer including a stack group in which high-refractive-index obliquely deposited films and low-refractive-index obliquely deposited films are alternately deposited, the high-refractive-index obliquely deposited films and the low-refractive-index obliquely deposited films having a same tilt direction with respect to a normal line of a surface on which the films are deposited.

A liquid-crystal display device according to the present disclosure for accomplishing the above-mentioned object is a liquid-crystal display device including:

a pair of substrates;

a liquid-crystal material layer sandwiched between the pair of substrates; and

an optical compensation element having an optical compensation layer, in which

the optical compensation layer includes a stack group in which high-refractive-index obliquely deposited films and low-refractive-index obliquely deposited films are alternately deposited, the high-refractive-index obliquely deposited films and the low-refractive-index obliquely deposited films having a same tilt direction with respect to a normal line of a surface on which the films are deposited.

An electronic apparatus according to the present disclosure for accomplishing the above-mentioned object is an electronic apparatus including

a liquid-crystal display device including
a pair of substrates,
a liquid-crystal material layer sandwiched between the pair of substrates, and
an optical compensation element having an optical compensation layer, in which

the optical compensation layer includes a stack group in which high-refractive-index obliquely deposited films and low-refractive-index obliquely deposited films are alternately deposited, the high-refractive-index obliquely deposited films and the low-refractive-index obliquely deposited films having a same tilt direction with respect to a normal line of a surface on which the films are deposited.

### BRIEF DESCRIPTION OF DRAWINGS

FIG. 1 is a schematic diagram for describing a liquid-crystal display device according to the present disclosure.

FIG. 2A is a schematic cross-sectional view for describing a basic configuration of the liquid-crystal display device. FIG. 2B is a schematic circuit diagram for describing a pixel in the liquid-crystal display device.

FIG. 3 is a schematic partial cross-sectional view for describing the liquid-crystal display device according to the present disclosure.

FIG. 4 is a schematic diagram for describing optical compensation in a liquid-crystal display device according to a reference example.

FIG. 5 is a schematic partial cross-sectional view for describing a configuration of an optical compensation layer according to the reference example.

FIG. 6 is a schematic diagram for describing optical compensation in a liquid-crystal display device according to a first embodiment.

FIG. 7A is a schematic diagram for describing a measurement method for a retardation property of the optical compensation layer according to the reference example. FIG. 7B is a schematic graph showing a relationship between the polar angle and the retardation property.

FIG. 8A is a schematic diagram for describing a measurement method for a retardation property when the optical compensation layer according to the reference example is tilted. FIG. 8B is a schematic graph showing a relationship between the polar angle and the retardation property.

FIG. 9 is a schematic partial cross-sectional view for describing a configuration of an optical compensation element to be used in the liquid-crystal display device according to the first embodiment.

FIG. 10A is a schematic diagram for describing a measurement method for a retardation property of the optical compensation element to be used in the liquid-crystal display device according to the first embodiment. FIG. 10B is a schematic graph showing a relationship between the polar angle and the retardation property.

FIG. 11 is a schematic partial cross-sectional view for describing a configuration in which anti-reflection layers are disposed above and below the optical compensation layer.

FIG. 12 is a schematic partial cross-sectional view for describing a liquid-crystal display device according to a second embodiment.

FIG. 13 is a schematic partial cross-sectional view for describing a configuration of an optical compensation element to be used in the liquid-crystal display device according to the second embodiment.

FIG. 14A is a schematic diagram for describing a measurement method for a retardation property of the optical compensation element to be used in the liquid-crystal display device according to the second embodiment. FIG. 14B is a schematic graph showing a relationship between the polar angle and the retardation property.

FIG. 15 is a schematic partial cross-sectional view for describing a liquid-crystal display device according to a third embodiment.

FIG. 16 is a schematic partial cross-sectional view for describing a liquid-crystal display device according to a fourth embodiment.

FIG. 17 is a schematic partial cross-sectional view for describing a liquid-crystal display device according to a modified example of the fourth embodiment.

FIG. 18 is a schematic partial cross-sectional view for describing a liquid-crystal display device according to a fifth embodiment.

FIG. 19 is a schematic partial cross-sectional view for describing an optical compensation element according to a sixth embodiment.

FIG. 20 is a schematic partial cross-sectional view for describing an optical compensation element according to a first modified example of the sixth embodiment.

FIG. 21 is a schematic partial cross-sectional view for describing an optical compensation element according to a second modified example of the sixth embodiment.

FIG. 22 is a schematic partial cross-sectional view for describing an optical compensation element according to a third modified example of the sixth embodiment.

FIG. 23 is a conceptual diagram of a projection-type display device.

FIG. 24 is an external view of a lens-interchangeable single-lens reflex type digital still camera, in which FIG. 24A shows a front view thereof and FIG. 24B shows a rear view thereof.

FIG. 25 is an external view of a head-mounted display.

FIG. 26 is an external view of a see-through head-mounted display.

FIG. 27 is a block diagram depicting an example of schematic configuration of a vehicle control system.

FIG. 28 is a diagram of assistance in explaining an example of installation positions of an outside-vehicle information detecting section and an imaging section.

### MODE(S) FOR CARRYING OUT THE INVENTION

Hereinafter, the present disclosure will be described on the basis of embodiments with reference to the drawings. The present disclosure is not limited to the embodiments and various numeric values and materials in the embodiments are exemplary. Hereinafter, the same elements or elements having the same functions will be denoted by the same reference signs and duplicate descriptions will be omitted. It should be noted that the descriptions will be given in the following order.

1. Descriptions Relating to General System Including Optical Compensation Element, Liquid-Crystal Display device, and Electronic Apparatus According to Present Disclosure

2. First Embodiment

3. Second Embodiment

4. Third Embodiment

5. Fourth Embodiment

6. Fifth Embodiment

7. Sixth Embodiment

8. Description of Electronic Apparatus, etc.

[Descriptions Relating to General System Including Optical Compensation Element, Liquid-Crystal Display Device, and Electronic Apparatus According to Present Disclosure]

Hereinafter, a liquid-crystal display device according to the present disclosure and a liquid crystal display device of an electronic apparatus according to the present disclosure will be simply referred to as a [liquid-crystal display device of the present disclosure] in some cases. Moreover, an optical compensation element according to the present disclosure and an optical compensation element to be used in the liquid-crystal display device of the present disclosure will be simply referred to as an [optical compensation element of the present disclosure] in some cases.

As described above, an optical compensation layer to be used in the optical compensation element of the present disclosure (hereinafter, simply referred to as [optical compensation layer of the present disclosure] in some cases) includes a stack group in which high-refractive-index obliquely deposited films and low-refractive-index obliquely deposited films that have a same tilt direction with respect to a normal line of a surface on which the films are deposited are alternately deposited.

The optical compensation layer of the present disclosure can be configured to include a first stack group in which high-refractive-index obliquely deposited films and low-refractive-index obliquely deposited films are alternately deposited, the high-refractive-index obliquely deposited films and the low-refractive-index obliquely deposited films having a first tilt direction with respect to the normal line of the surface on which the films are deposited and a second stack group in which high-refractive-index obliquely deposited films and low-refractive-index obliquely deposited films are alternately deposited, the high-refractive-index obliquely deposited films and the low-refractive-index obliquely deposited films having a second tilt direction different from the first tilt direction.

In this case, the first tilt direction and the second tilt direction can be configured to be set so that components conforming to the surface on which the films are deposited are orthogonal.

In the optical compensation layer of the present disclosure having the above-mentioned various favorable configurations, a deposition angle of the high-refractive-index obliquely deposited films and the low-refractive-index obliquely deposited films with respect to the normal line of the surface on which the films are deposited can be configured to be 45 degrees or less. If the deposition angle of the high-refractive-index obliquely deposited films and the low-refractive-index obliquely deposited films with respect to the normal line of the surface on which the films are deposited is too large, favorable properties cannot be obtained. Therefore, it is desirable that the deposition angle with respect to the normal line of the surface on which the films are deposited be configured to be 45 degrees or less.

The film thickness and the number of stacks of the high-refractive obliquely deposited film and the low-refractive-index obliquely deposited film may be set as appropriate in accordance with the specifications of the optical compensation layer. For example, the film thickness can be approximately 10 to 50 nanometers. It is sufficient that a film thickness ratio of the high-refractive obliquely deposited film and the low-refractive-index obliquely deposited film is approximately 1:1. It is sufficient that the number of stacks thereof is, for example, approximately 10 to 200. The high-refractive obliquely deposited film and the low-refractive-index obliquely deposited film can be deposited by a well-known deposition method, e.g., a CVD method or PVD method.

The high-refractive obliquely deposited film and the low-refractive-index obliquely deposited film made of, for example, an inorganic insulating material. Examples of the constituent material of the high-refractive obliquely deposited film can include silicon nitride (SiNₓ), tantalum oxide (Ta₂O₅), titanium oxide (TiO₂), and the like. Moreover, examples of the constituent material of the low-refractive obliquely deposited film can include silicon oxide (SiOₓ), silicon oxynitride (SiOₓN_{y}), and the like.

The liquid-crystal display device of the present disclosure having the above-mentioned various favorable configurations can be configured to further include, as the pair of substrates, a transistor array substrate and an opposite substrate disposed to be opposite to the transistor array substrate.

In this case, the optical compensation layer may be configured to be provided in the opposite substrate or the optical compensation layer may be configured to be provided in the transistor array substrate.

Alternatively, the optical compensation layer may be configured to be provided in the opposite substrate and the transistor array substrate.

In this case, the first stack group in which the high-refractive-index obliquely deposited films and the low-refractive-index obliquely deposited films are alternately deposited can be configured to be provided in the opposite substrate, the high-refractive-index obliquely deposited films and the low-refractive-index obliquely deposited films having the first tilt direction with respect to the normal line of the surface on which the films are deposited, and the second stack group in which the high-refractive-index obliquely deposited films and the low-refractive-index obliquely deposited films are alternately deposited can be configured to be provided in the transistor array substrate, the high-refractive-index obliquely deposited films and the low-refractive-index obliquely deposited films having the second tilt direction different from the first tilt direction.

As described above, the first tilt direction and the second tilt direction can be configured to be set so that components conforming to the surface on which the films are deposited are orthogonal. Moreover, as described above, it is desirable that the deposition angle with respect to the normal line of the surface on which the films are deposited be configured to be 45 degrees or less.

In the liquid-crystal display device of the present disclosure having the above-mentioned various favorable configurations, a black matrix and/or a micro-lens can be configured to be formed in the opposite substrate. Alternatively, the black matrix and/or the micro-lens can be configured to be formed in the transistor array substrate.

The optical compensation element according to the present disclosure includes an optical compensation layer including a stack group in which high-refractive-index obliquely deposited films and low-refractive-index obliquely deposited films are alternately deposited, the high-refractive-index obliquely deposited films and the low-refractive-index obliquely deposited films having a same tilt direction with respect to a normal line of a surface on which the films are deposited. In addition, the optical compensation element can be configured to include a substrate and an optical compensation layer formed on the substrate. In this case, a black matrix and/or a micro-lens can be configured to be formed in the substrate. As the substrate to be used for the optical compensation element, a substrate made of a transparent material, such as plastics, glass, and quartz, can be used.

As described above, the liquid-crystal display device of the present disclosure can be configured to further include, as the pair of substrates, a transistor array substrate and an opposite substrate disposed to be opposite to the transistor array substrate.

In a case of a transistor array substrate to be used in a see-through-type liquid-crystal display device, the pixel electrode can be made of a transparent conductive material such as indium tin oxide (ITO) and indium zinc oxide (IZO). In a case of a transistor array substrate to be used in a reflection-type liquid-crystal display device, the pixel electrode can be made of, for example, a metal material including metal, such as aluminum (Al) and silver (Ag), and alloys thereof. It should be noted that the above-mentioned transparent conductive material and those metal materials may be stacked and formed in some cases.

A substrate made of a transparent material such as plastics, glass, and quartz or a substrate made of a semiconductor material such as silicon can be used as the transistor array substrate. A transistor that constitutes a switching element can be configured by forming and machining a semiconductor material layer or the like on the substrate, for example.

A substrate made of a transparent material such as plastics, glass, and quartz can be used as the opposite substrate. The opposite electrode can be formed on the opposite substrate by using a transparent conductive material such as indium tin oxide (ITO) and indium zinc oxide (IZO). The opposite electrode functions as a common electrode for the respective pixels of the liquid-crystal display device.

The constituent materials of various wires and electrodes or contacts are not particularly limited, and for example, metal materials including aluminum (Al), aluminum alloys such as Al—Cu and Al—Si, tungsten (W), tungsten alloys such as tungsten silicide (WSi) can be used.

The constituent materials of an interlayer insulating layer, a planarization film, and the like are not particularly limited, and inorganic materials such as silicon oxide, silicon oxynitride, and silicon nitride and organic materials such as polyimide can be used.

A deposition method for the semiconductor material layer, the wires, the electrodes, the insulating layer, the insulating film, and the like is not particularly limited, and they can be deposited by a well-known deposition method without interfering with the practice of the present disclosure. The same applies to a patterning method therefor.

The liquid-crystal display device may be configured to display monochrome images or may be configured to display color images. Some image resolutions (3840, 2160), (7680, 4320), and the like can be exemplified as the pixel values of the liquid-crystal display device in addition to U-XGA (1600, 1200), HD-TV (1920, 1080), Q-XGA (2048, 1536), though not limited to these values.

Moreover, various electronic apparatuses having an image display function can be exemplified as an electronic apparatus including the liquid-crystal display device of the present disclosure in addition to direct-view-type and projection-type display devices.

Various conditions in the present specification can be satisfied both in a case where the conditions are strictly established and a case where the conditions are substantially established. Variations caused by design or manufacture factors should be allowed. Moreover, the respective drawings used in the following descriptions are schematic and do not show actual dimensions and the rates thereof.

### First Embodiment

A first embodiment pertains to an optical compensation element, a liquid-crystal display device, and an electronic apparatus according to the present disclosure.

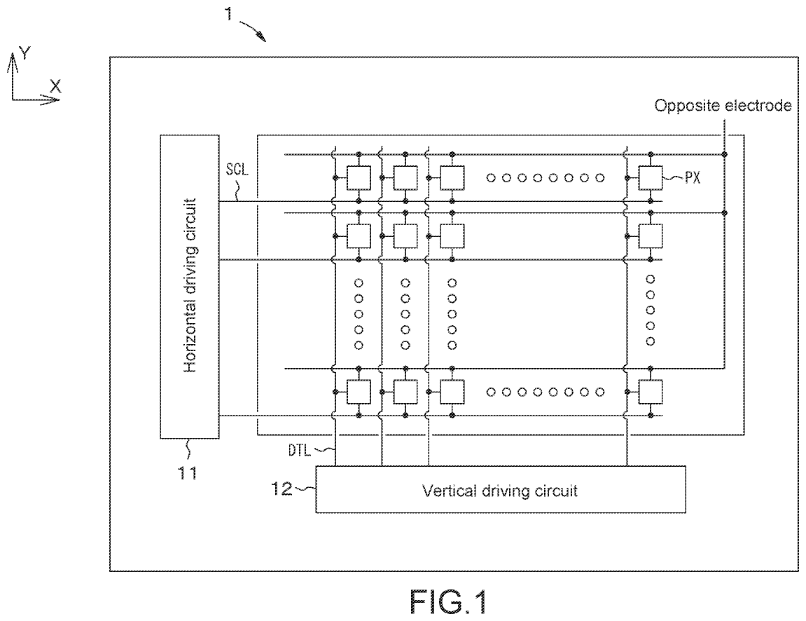

FIG. 1 is a schematic diagram for describing the liquid-crystal display device according to the present disclosure.

The liquid-crystal display device according to the first embodiment is an active matrix liquid-crystal display device. As shown in FIG. 1, a liquid-crystal display device 1 includes pixels PX arranged in a matrix form and various circuits such as a horizontal driving circuit 11 and a vertical driving circuit 12 for driving the pixels PX. The reference sign SCL denotes a scanning line for scanning the pixels PX and the reference sign DTL denotes a signal line for supplying the pixels PX with various voltages. As the pixels PX, total M X N pixels, for example, M pixels (horizontal) and N pixels (vertical), are arranged in a matrix form. The opposite electrode shown in FIG. 1 is provided as a common electrode for the respective liquid-crystal cells. It should be noted that in the example shown in FIG. 1, the horizontal driving circuit 11 and the vertical driving circuit 12 are each disposed on one end side of the liquid-crystal display device 1, though it is merely exemplary.

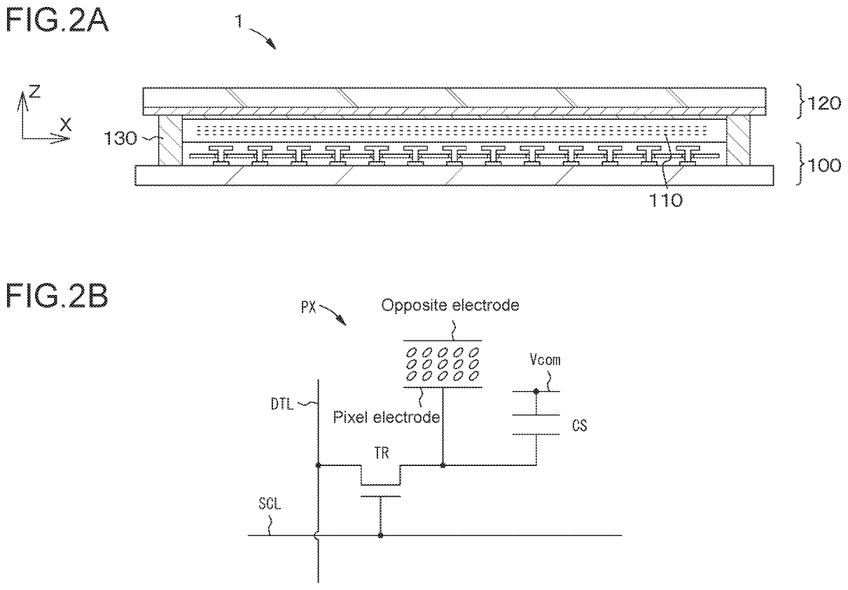

FIG. 2A is a schematic cross-sectional view for describing a basic configuration of the liquid-crystal display device. FIG. 2B is a schematic circuit diagram for describing a pixel in the liquid-crystal display device.

As shown in FIG. 2A, the liquid-crystal display device 1 includes a pair of substrates constituted by a transistor array substrate 100 and an opposite substrate 120 disposed to be opposite to the transistor array substrate 100 and a liquid-crystal material layer 110 sandwiched between the pair of substrates. The transistor array substrate 100 and the opposite substrate 120 are sealed by a seal portion 130. The seal portion 130 has an annular shape surrounding the liquid-crystal material layer 110.

As will be described later, the transistor array substrate 100 is configured by, for example, stacking various components on the supporting substrate made of a glass material or the like, for example. The liquid-crystal display device 1 is a see-through-type liquid-crystal display device.

The opposite substrate 120 is provided with an opposite electrode made of a transparent conductive material such as ITO, for example. More specifically, the opposite substrate 120 is constituted by, for example, a rectangular substrate made of a transparent glass, an opposite electrode provided in a surface of the substrate, which is located on the side of the liquid-crystal material layer 110, an alignment film provided on the opposite electrode, and the like. Moreover, the transistor array substrate 100 and the opposite substrate 120 are provided with a polarization plate, an alignment film, and the like as appropriate. It should be noted that for the sake of illustration, the transistor array substrate 100 and the opposite substrate 120 of FIG. 2A are shown in a simplified state.

As shown in FIG. 2B, a liquid-crystal cell that constitute the pixel PX includes a pixel electrode provided in the transistor array substrate 100 and a liquid-crystal material layer and an opposite electrode in a portion corresponding to the pixel electrode. In order to prevent degradation of the liquid-crystal material layer, a common potential V. as a positive electrode property or negative electrode property is alternately applied on the opposite electrode when the liquid-crystal display device 1 is driven. It should be noted that each element excluding the liquid-crystal material layer and the opposite electrode in the pixel PX is formed in the transistor array substrate 100 shown in FIG. 2A.

As it is clear from the connection relationship of FIG. 2B, a pixel voltage supplied from a signal line DTL is applied on the pixel electrode via a transistor TR that is held in a conduction state in accordance with a scanning signal of a scanning line SCL. The pixel electrode is electrically connected with one electrode of a capacitor structure CS, and therefore the pixel voltage is also applied on the one electrode of the capacitor structure CS. It should be noted that the common potential V_{com} is applied on the other electrode of the capacitor structure CS. With this configuration, the voltage of the pixel electrode is retained by the capacitance of the liquid-crystal cell and the capacitor structure CS also after the transistor TR is put in a non-conduction state.

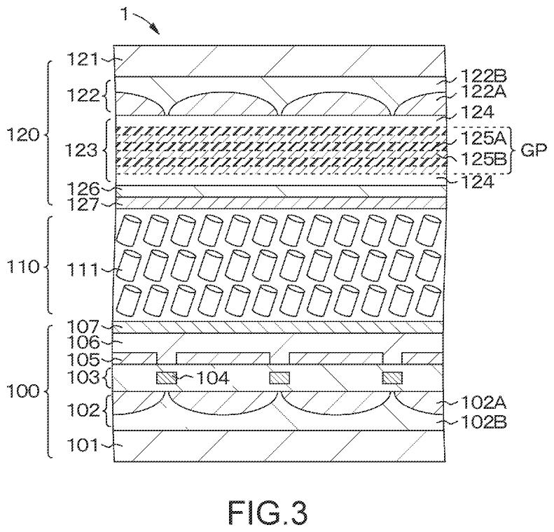

Although it will be described in detail with reference to FIGS. 3 to 11, the display device 1 according to the first embodiment includes the optical compensation element having the optical compensation layer. The optical compensation layer includes a stack group in which high-refractive-index obliquely deposited films and low-refractive-index obliquely deposited films are alternately deposited, the high-refractive-index obliquely deposited films and the low-refractive-index obliquely deposited films having a same tilt direction with respect to a normal line of a surface on which the films are deposited. A deposition angle of the high-refractive-index obliquely deposited films and the low-refractive-index obliquely deposited films with respect to the normal line of the surface on which the films are deposited is 45 degrees or less.

FIG. 3 is a schematic partial cross-sectional view for describing the liquid-crystal display device according to the present disclosure.

The liquid-crystal display device 1 includes the transistor array substrate 100, the opposite substrate 120, and the liquid-crystal material layer 110 sandwiched between the transistor array substrate 100 and the opposite substrate 120.

The transistor array substrate 100 includes

a supporting substrate 101 made of a transparent material,

a micro-lens layer 102 that is disposed on the supporting substrate 101 and includes micro-lenses 102A and a filler layer 102B,

a wiring layer 103 that is disposed on the micro-lens layer 102 and includes thin-film transistors, various wires, a black matrix 104, and the like,

a pixel electrode 105 formed on the wiring layer 103,

a planarization film 106 formed on the pixel electrode 105, and

an alignment film 107 formed on the planarization film 106.

The opposite substrate 120 disposed to be opposite to the transistor array substrate 100 includes

a supporting substrate 121 made of a transparent material,

a micro-lens layer 122 that is disposed on the supporting substrate 121 and includes a micro-lens 122A and a filler layer 122B,

an optical compensation element 123 that is disposed on the micro-lens layer 122 and has an optical compensation layer GP sandwiched by base layers 124,

an opposite electrode (common electrode) 126 formed on the optical compensation element 123, and

an alignment film 127 formed on the common electrode 126.

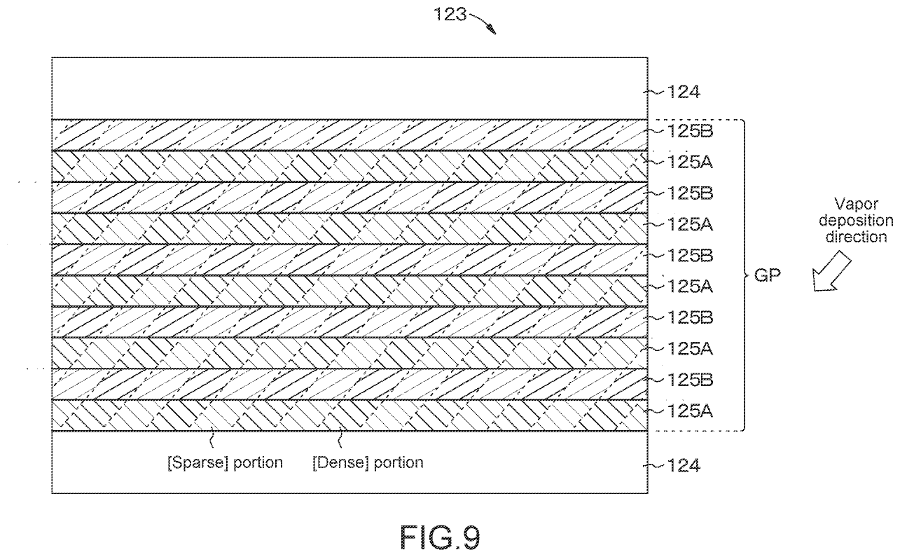

The optical compensation layer GP is provided in the opposite substrate 120. The optical compensation layer GP includes a stack group in which high-refractive-index obliquely deposited films 125A and low-refractive-index obliquely deposited films 125B, the high-refractive-index obliquely deposited films 125A and the low-refractive-index obliquely deposited films 125B having a same tilt direction with respect to a normal line of a surface on which the films are deposited are alternately deposited. The optical compensation layer GP will be described later in detail with reference to FIG. 9 to be described later.

It should be noted that polarization films (not shown) are arranged in a relationship of crossed-nicols or parallel-nicols in the transistor array substrate 100 and the opposite substrate 120 in accordance with the specifications of the liquid-crystal display device 1.

The liquid-crystal display device 1 can be basically manufactured by using well-known materials and well-known methods. It should be noted that a manufacturing method for the optical compensation layer GP will be described later.

The liquid-crystal material layer 110 is sandwiched by the transistor array substrate 100 and the opposite substrate 120. The alignment films 107 and 127 set a direction of initial alignment of liquid-crystal molecules 111 of the liquid-crystal material layer 110. In a state in which an electric field is applied on the liquid-crystal material layer 110, the liquid-crystal molecules 111 are aligned approximately vertically, forming a predetermined tilt angle. The liquid-crystal display device 1 is a liquid-crystal display device of a so-called vertical aligned type (VA mode).

Here, for the sake of easy understanding of the present disclosure, optical compensation in a liquid-crystal display device according to a reference example will be described.

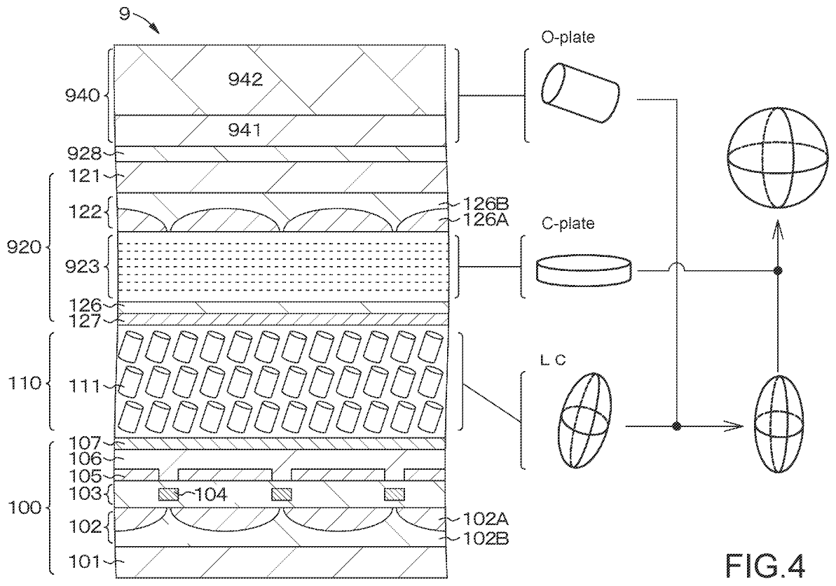

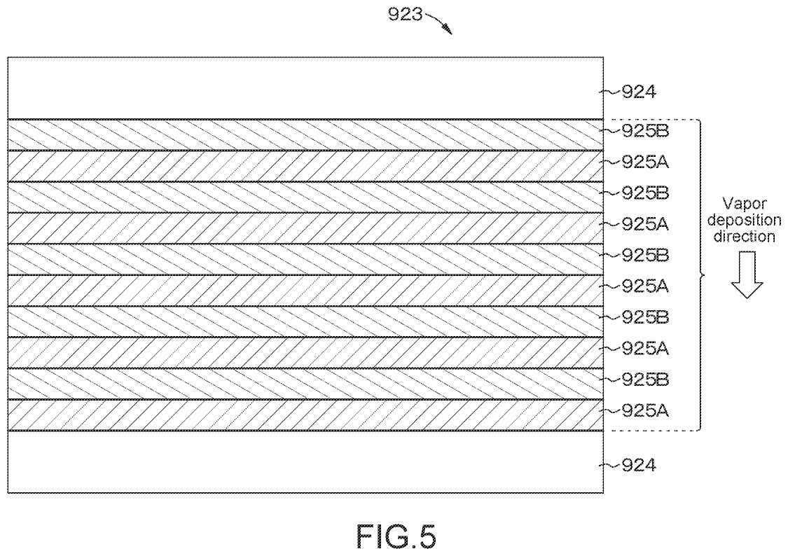

FIG. 4 is a schematic diagram for describing the optical compensation in the liquid-crystal display device according to the reference example. FIG. 5 is a schematic partial cross-sectional view for describing a configuration of the optical compensation layer according to the reference example.

A liquid-crystal display device 9 according to the reference example has a structure in which the configuration of the opposite substrate differs and an optical compensation element including an optical compensation layer that constitutes an O-plate is disposed on the opposite substrate, as compared to the liquid-crystal display device 1 of the present disclosure shown in FIG. 3. That is, an opposite substrate 920 shown in FIG. 4 has a configuration in which the optical compensation element 123 of the opposite substrate 120 shown in FIG. 3 is replaced by an optical compensation element 923 that constitutes a C-plate. Moreover, an optical compensation element 940 is constituted by a transparent substrate 941 and an optical compensation layer 942 that is formed thereon and constitutes an O-plate. The optical compensation element 940 is attached on the supporting substrate 121 with an adhesion resin 928.

As shown in FIG. 5, the optical compensation element 923 includes a stack group in which high-refractive index deposited films 925A and low-refractive deposition films 925B are alternately deposited. The stack group is sandwiched by base layers 924. A vapor deposition direction of the high-refractive index deposited films 925A and the low-refractive index deposited films 925B is a normal line direction of a surface on which the films are deposited. The optical compensation element 923 that constitutes the C-plate has an extraordinary axis orthogonal to the plane and prevents retardation with respect to normal incident light from occurring.

As shown on the left side of FIG. 4, the refractive-index anisotropy due to the tilt angle of the liquid-crystal molecules 111 compensated for by the optical compensation layer 942 on the supporting substrate 121 and the refractive-index anisotropy of the liquid-crystal material layer 110 is compensated for by the optical compensation element 923. By using those two optical compensation layers, the high-contrast of a displayed image can be achieved.

Hereinabove, the optical compensation in the liquid-crystal display device 9 according to the reference example has been described.

In the liquid-crystal display device 9 according to the reference example, the optical compensation layer 942 that constitutes the O-plate is fixed as the optical compensation element 940 of the other substrate outside the opposite substrate 920 with the adhesion resin 928. Thus, the optical compensation effect is likely to be insufficient because the optical compensation layer 942 is located outside the opposite substrate 920. Moreover, there are still a problem of light resistance of the adhesion resin 928, a problem on the properties, which is caused by position deviation at the time of adhesion or the like, a problem related to an increase in costs due to an increase in the number of processes and the number of components, and the like.

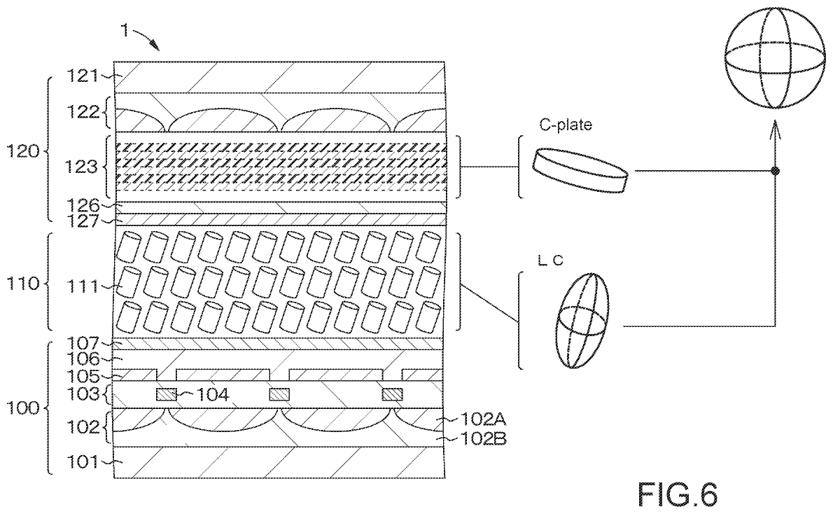

In view of such problems, an optical compensation element capable of optically tilting the optical properties without physically tilting the optical compensation element that constitutes the C-plate is used in the present disclosure. Accordingly, the high-contrast of a displayed image can be achieved without disposing the O-plate. FIG. 6 is a schematic diagram for describing optical compensation in the liquid-crystal display device according to the first embodiment.

For the sake of easy understanding of the present disclosure, a property change due to tilting the optical compensation element according to the reference example will be first described.

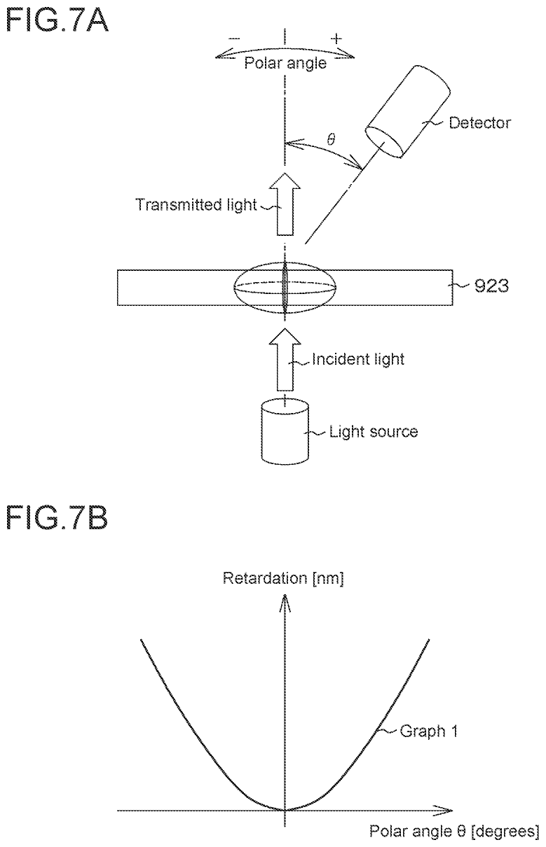

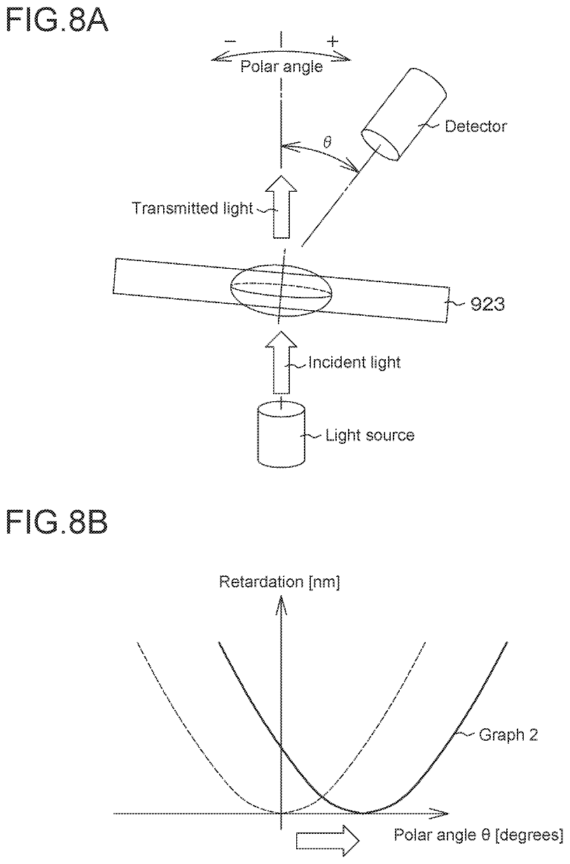

FIG. 7A is a schematic diagram for describing a measurement method for a retardation property of the optical compensation layer according to the reference example. FIG. 7B is a schematic graph showing a relationship between the polar angle and the retardation property. FIG. 8A is a schematic diagram for describing a measurement method for a retardation property of the optical compensation layer according to the reference example is tilted. FIG. 8B is a schematic graph showing a relationship between the polar angle and the retardation property.

As described above, the optical compensation element 923 that constitutes the C-plate has an extraordinary axis orthogonal to the plane and prevents retardation with respect to normal incident light from occurring. In a case where the polar angle θ is zero degrees in FIG. 7A, the shape of a cross-section of an index ellipsoid, which is taken with respect to the plane of light incidence, is circular. Thus, the retardation is zero. In contrast, in a case where the polar angle θ is not zero degrees, the shape of the cross-section of the index ellipsoid, which is taken with respect to the plane of light incidence, is oval. As a result, the change in the retardation with respect to the polar angle θ is represented as in Graph 1 shown in FIG. 7B.

FIG. 8A shows a state in which the optical compensation element 923 that constitutes the C-plate is tilted by an angle α with respect to FIG. 7A. In this case, where the polar angle θ=α, the shape of the cross-section of the index ellipsoid, which is taken with respect to the plane of light incidence, is circular. Thus, the retardation is zero. Where the polar angle θ≠α, the shape of the cross-section of the index ellipsoid, which is taken with respect to the plane of light incidence, is oval. In other words, the optical properties are also shift by the angle α with respect to FIG. 7A.

As a result, the change in the retardation with respect to the polar angle θ is represented as in Graph 2 shown in FIG. 8B. Thus, the tilted optical compensation element 923 exhibits properties obtained by adding the properties of the O-plate to the properties of the C-plate.

In this manner, for example, also in the liquid-crystal display device 9 shown in FIG. 4, the O-plate can be omitted by disposing the optical compensation element 923 in a tilted state. However, for physically tilting the optical compensation element 923, it is necessary to secure a space for tilting and it is also necessary to dispose the optical compensation element 923 as another member, for example.

In view of this, the optical compensation element 123 used in the first embodiment is configured so that the optical properties are shift without tilting the optical compensation element 123 itself. That is, the optical compensation element 123 exhibits properties obtained by adding the properties of the O-plate to the properties of the C-plate.

FIG. 9 is a schematic partial cross-sectional view for describing a configuration of the optical compensation element to be used in the liquid-crystal display device according to the first embodiment.

The optical compensation layer GP includes a stack group in which high-refractive-index obliquely deposited films 125A and low-refractive-index obliquely deposited films 125B are alternately deposited, the high-refractive-index obliquely deposited films 125A and the low-refractive-index obliquely deposited films 125B having a same tilt direction (vapor deposition direction) with respect to the normal line of the surface on which the films are deposited. The high-refractive-index obliquely deposited film 125A is made of silicon nitride (SiNₓ), for example, and the low-refractive-index obliquely deposited film 125B is made of silicon oxide (SiOₓ), for example.

In a process in which the high-refractive-index obliquely deposited films 125A and the low-refractive-index obliquely deposited films 125B are alternately stacked, each of the films is obliquely deposited. A deposition angle with respect to the normal line of the surface on which the films are deposited and the number of stacks of the deposition are set as appropriate in accordance with required optical properties. It should be noted that as the deposition angle of oblique evaporation becomes unnecessarily larger, the effect of adding the properties of the O-plate to the properties of the C-plate lowers. Thus, it is favorable that the tilt angle with respect to the normal line of the surface on which the films are deposited in the high-refractive-index obliquely deposited films 125A and the low-refractive-index obliquely deposited films 125B is set to be 45 degrees or less.

The optical compensation layer GP of the optical compensation element 123 can be obtained by, for example, continuously alternately depositing the high-refractive-index obliquely deposited films 125A and the low-refractive-index obliquely deposited films 125B on a predetermined base material in a predetermined tilt direction by oblique evaporation.

As shown in FIG. 9, a [sparse] portion and a [dense] portion exist in each of the obliquely deposited high-refractive-index obliquely deposited films 125A and low-refractive-index obliquely deposited films 125B. Moreover, a direction in which those portions extend is a direction approximately conforming to the vapor deposition direction in each of the layers that constitute the optical compensation layer GP.

Typically, in an obliquely deposited film made of a single material, the tilt direction of the film is the slow axis of the refractive index. In contrast, in the optical compensation layer GP in which the high-refractive-index obliquely deposited films 125A and the low-refractive-index obliquely deposited films 125B are stacked as a plurality of layers, a property that a direction approximately orthogonal to the tilt direction of the film is the slow axis of the refractive index is exhibited.

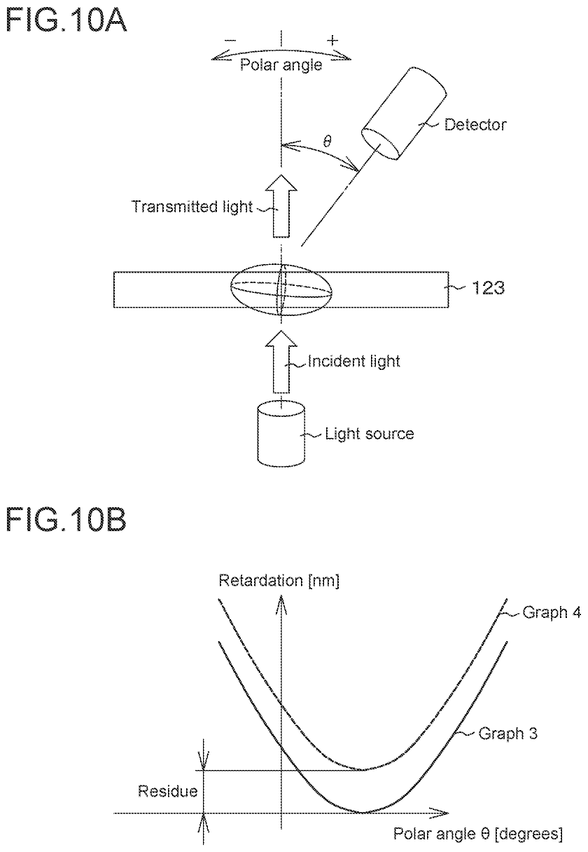

FIG. 10A is a schematic diagram for describing a measurement method for a retardation property of the optical compensation element to be used in the liquid-crystal display device according to the first embodiment. FIG. 10B is a schematic graph showing a relationship between the polar angle and the retardation property.

As shown in FIG. 10A and FIG. 10B, the optical compensation element 123 has the optical properties tilted without physically tilting the optical compensation element 123 itself. Graph 3 shown in FIG. 10B represents an ideal case in the relationship between the polar angle and the retardation property. In reality, a property that a certain residue remains at the minimum value of the retardation as shown in Graph 4 of FIG. 10B is exhibited in some cases.

As described above, the optical compensation element 123 has the properties of the O-plate added to the properties of the C-plate. Accordingly, the high-contrast of a displayed image can be achieved without disposing the O-plate. In addition, reduction of the manufacturing processes and the number of components can be achieved. Moreover, a liquid-crystal display device with high reliability can be obtained because all the optical compensation elements can be disposed in the liquid-crystal display device.

It should be noted that anti-reflection layers may be formed to sandwich the optical compensation layer GP for preventing reflection of external light and the like. The same applies to other embodiments to be described later.

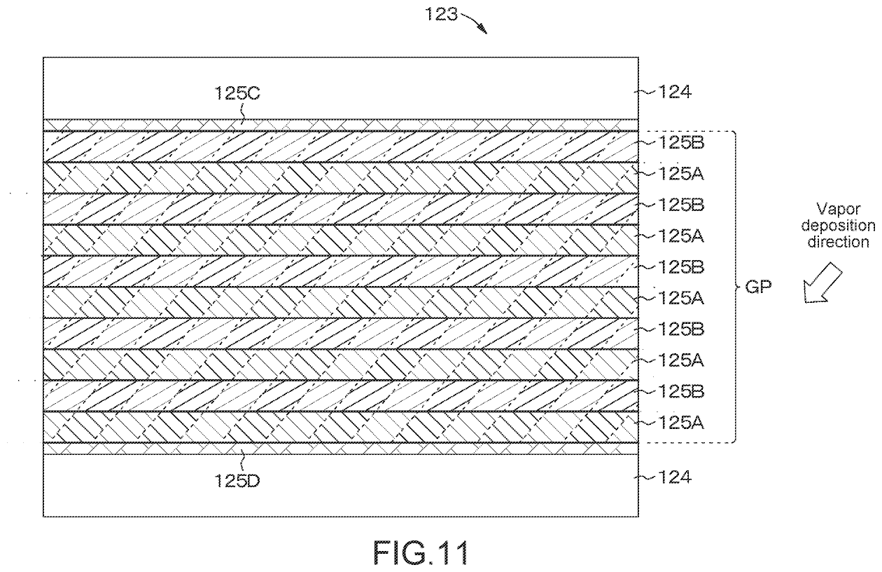

FIG. 11 is a schematic partial cross-sectional view for describing a configuration in which anti-reflection layers are disposed above and below the optical compensation layer. The configurations of anti-reflection layers 125C and 125D are not particularly limited. The anti-reflection layer 125D can be made of, for example, a combination of silicon oxide (SiOₓ) and silicon nitride (SiNₓ).

### Second Embodiment

A second embodiment also pertains to an optical compensation element, a liquid-crystal display device, and an electronic apparatus according to the present disclosure.

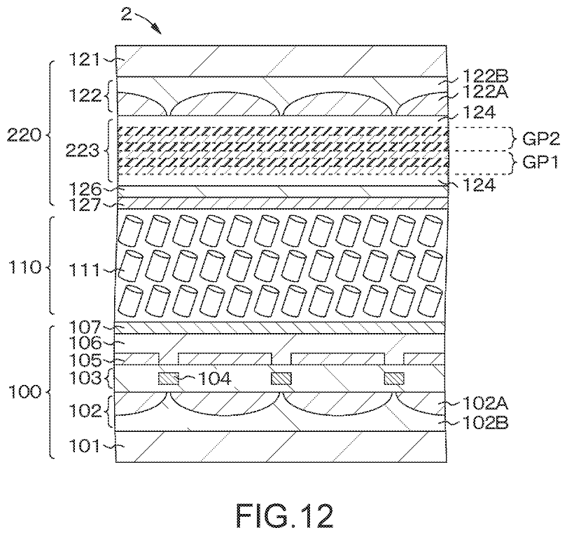

FIG. 12 is a schematic partial cross-sectional view for describing the liquid-crystal display device according to the second embodiment. In the schematic diagram of the liquid-crystal display device according to the second embodiment, it is sufficient that the liquid-crystal display device 1 in FIG. 1 is replaced by a liquid-crystal display device 2. Moreover, in the schematic cross-sectional view for describing a basic configuration of the liquid-crystal display device, it is sufficient that the liquid-crystal display device 1 in FIG. 2A is replaced by the liquid-crystal display device 2 and the opposite substrate 120 is replaced by an opposite substrate 220.

The liquid-crystal display device 2 has a configuration in which the optical compensation element 123 is replaced by an optical compensation element 223 as compared to the liquid-crystal display device 1 described in the first embodiment. Like the optical compensation element 123, the optical compensation element 223 includes a stack group in which high-refractive-index obliquely deposited films and low-refractive-index obliquely deposited films are alternately deposited, the high-refractive-index obliquely deposited films and the low-refractive-index obliquely deposited films having a same tilt direction with respect to a normal line of a surface on which the films are deposited.

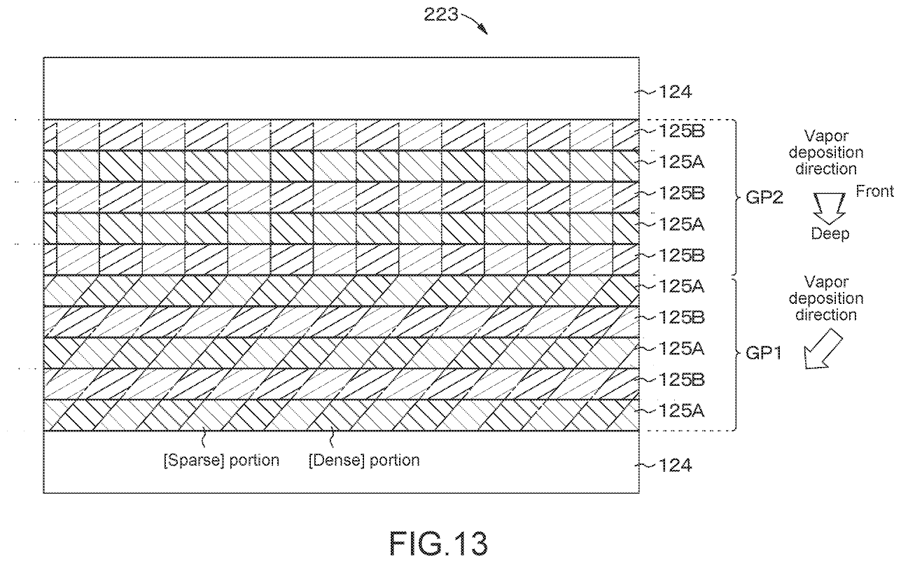

FIG. 13 is a schematic partial cross-sectional view for describing a configuration of the optical compensation element to be used in the liquid-crystal display device according to the second embodiment.

As in the first embodiment, also in the optical compensation element 223, the high-refractive-index obliquely deposited film 125A is made of silicon nitride (SiNₓ), for example, and the low-refractive-index obliquely deposited film 125B is made of silicon oxide (SiOₓ), for example. It should be noted that the optical compensation layer of the optical compensation element 223 includes a first stack group GP1 in which high-refractive-index obliquely deposited films and low-refractive-index obliquely deposited films are alternately deposited, the high-refractive-index obliquely deposited films and the low-refractive-index obliquely deposited films having a first tilt direction with respect to the normal line of the surface on which the films are deposited and a second stack group GP2 in which high-refractive-index obliquely deposited films and low-refractive-index obliquely deposited films are alternately deposited, the high-refractive-index obliquely deposited films and the low-refractive-index obliquely deposited films having a second tilt direction different from the first tilt direction.

In the optical compensation element 123 described in the first embodiment, a certain residue remains at the minimum value of the retardation as shown in the graph 4 of FIG. 10B is exhibited in some cases. In the optical compensation element 223, the stack group GP1 and the stack group GP2, which are different from each other in tilt direction, are superimposed, and the residue of the retardation can be thus overcome.

The tilt direction (vapor deposition direction) of each of the obliquely deposited films that constitute the first stack group GP1 is a left downward direction in parallel with the sheet of FIG. 13. In contrast, the tilt direction (vapor deposition direction) of each of the obliquely deposited films that constitute the second stack group GP2 is a direction of lowering toward the deep side of the sheet from the front of the sheet. The first tilt direction and the second tilt direction are set so that components conforming to the surface on which the films are deposited are orthogonal.

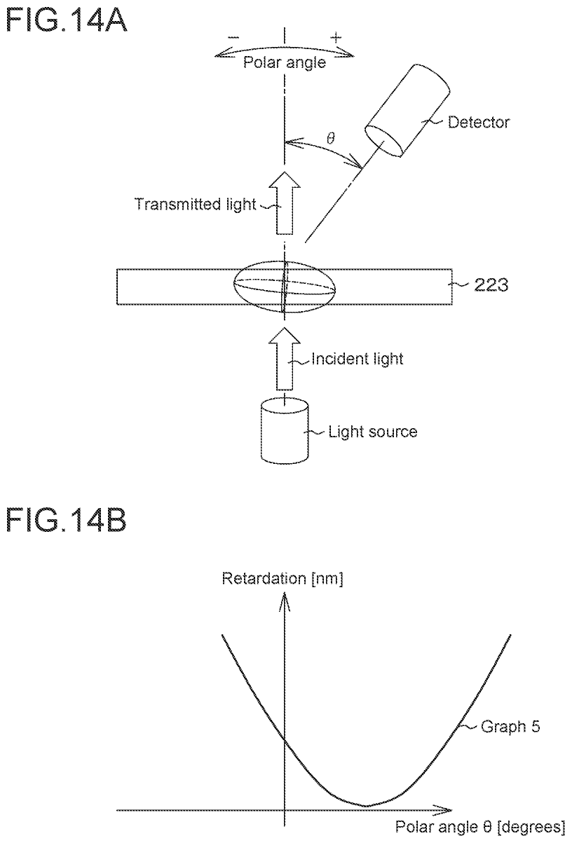

FIG. 14A is a schematic diagram for describing a measurement method for a retardation property of the optical compensation element to be used in the liquid-crystal display device according to the second embodiment. FIG. 14B is a schematic graph showing a relationship between the polar angle and the retardation property.

As shown in FIG. 14A, also in the optical compensation element 223, the optical properties are tilted without physically tilting the optical compensation element 223 itself. In addition, the stack group GP1 and the stack group GP2 are superimposed on each other, and the residue of the retardation is thus overcome. Thus, the relationship between the polar angle and the retardation property in the optical compensation element 223 is as in Graph 5 shown in FIG. 14B.

The optical compensation layer of the optical compensation element 223 can be formed in a process as follows, for example.

When forming the stack group GP1 having the first tilt direction a predetermined base material, the high-refractive-index obliquely deposited films 125A and the low-refractive-index obliquely deposited films 125B are alternately deposited by oblique evaporation. In addition, when forming the stack group GP2 having the second tilt direction, the base material is rotated about the normal line of the base material as the axis, and the high-refractive-index obliquely deposited films 125A and the low-refractive-index obliquely deposited films 125B are continuously alternately deposited by oblique evaporation. Accordingly, the stack group GP1 and the stack group GP2 having the tilt direction different from that of the stack group GP1 can be obtained.

Alternatively, when forming the stack group GP1 and the stack group GP2, the deposition may be performed by changing a tilt direction of an evaporation source. For example, it is also possible to separately provide an evaporation source for the stack group GP1 and an evaporation source for the stack group GP2 so as to have different angles of incidence and to switch from one of the evaporation sources to another as appropriate, for example.

It should be noted that it is favorable that a base material such as a wafer is fixed and deposited in a face-down manner. The face-down manner can prevent particles from entering during the deposition.

### Third Embodiment

A third embodiment also pertains to an optical compensation element, a liquid-crystal display device, and an electronic apparatus according to the present disclosure.

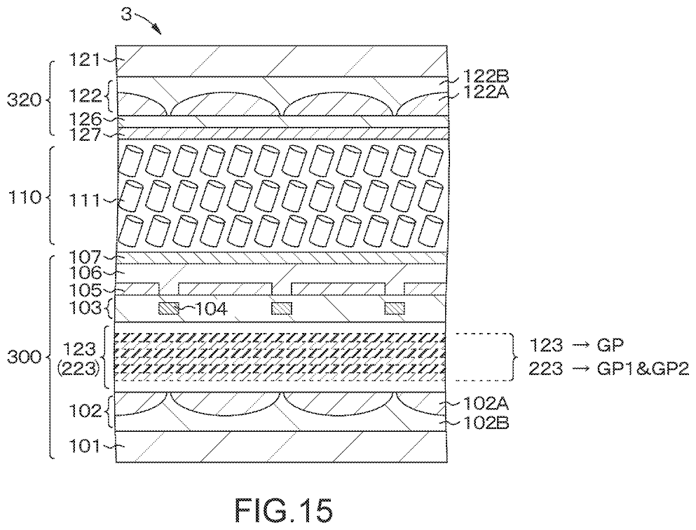

FIG. 15 is a schematic partial cross-sectional view for describing the liquid-crystal display device according to the third embodiment. In the schematic diagram of the liquid-crystal display device according to the third embodiment, it is sufficient that the liquid-crystal display device 1 in FIG. 1 is replaced by a liquid-crystal display device 3. Moreover, in the schematic cross-sectional view for describing a basic configuration of the liquid-crystal display device, it is sufficient that the liquid-crystal display device 1 in FIG. 2A is replaced by the liquid-crystal display device 3, the transistor array substrate 100 is replaced by a transistor array substrate 300, and the opposite substrate 120 is replaced by an opposite substrate 320.

In the first embodiment and the second embodiment, the optical compensation layer is provided in the opposite substrate. In contrast, in the liquid-crystal display device 3, the optical compensation layer is provided on the side of the transistor array substrate.

The opposite substrate 320 shown in FIG. 3 has a configuration obtained by removing the optical compensation element 123 from the opposite substrate 120 shown in FIG. 3. In addition, the transistor array substrate 300 has a configuration in which the optical compensation element 123 described in the first embodiment or the optical compensation element 223 described in the second embodiment is disposed between the micro-lens layer 102 and the wiring layer 103 in the transistor array substrate 100 shown in FIG. 3.

The optical properties in the liquid-crystal display device 3 are similar to the properties described in the first embodiment or the second embodiment, and therefore the description will be omitted.

### Fourth Embodiment

A fourth embodiment also pertains to an optical compensation element, a liquid-crystal display device, and an electronic apparatus according to the present disclosure.

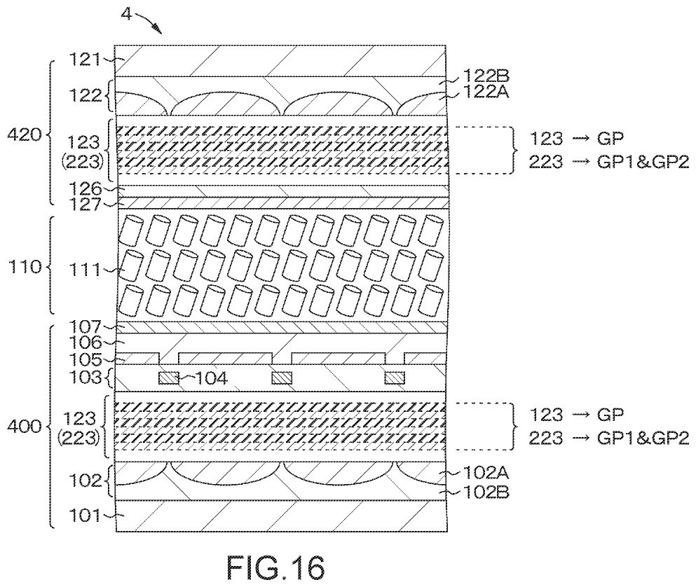

FIG. 16 is a schematic partial cross-sectional view for describing the liquid-crystal display device according to the fourth embodiment. In the schematic diagram of the liquid-crystal display device according to the third embodiment, it is sufficient that the liquid-crystal display device 1 in FIG. 1 is replaced by a liquid-crystal display device 4. Moreover, in the schematic cross-sectional view for describing a basic configuration of the liquid-crystal display device, it is sufficient that the liquid-crystal display device 1 in FIG. 2A is replaced by the liquid-crystal display device 4, the transistor array substrate 100 is replaced by a transistor array substrate 400, and the opposite substrate 120 is replaced by an opposite substrate 420.

In the first embodiment and the second embodiment, the optical compensation layer is provided only in the opposite substrate. Moreover, in the third embodiment, the optical compensation layer is provided only in the transistor array substrate. In contrast, in the liquid-crystal display device 4, optical compensation layers GP are provided in the opposite substrate 420 and the transistor array substrate 400.

It is necessary to set the optical compensation layer to have a certain thickness for obtaining predetermined properties. Therefore, in the first embodiment and the second embodiment, the optical compensation layer can be a factor that bends the opposite substrate. Moreover, in the third embodiment, the optical compensation layer can be a factor that bends the transistor array substrate.

In the liquid-crystal display device 4, the optical compensation layers GP are provided in the opposite substrate 420 and the transistor array substrate 400. Thus, the thickness of the optical compensation layers provided in the opposite substrate 420 and the transistor array substrate 400 can be approximately half of that in a case where the optical compensation layer GP is provided only on one side. Therefore, bending of the opposite substrate 420 and the transistor array substrate 400 can be reduced.

The opposite substrate 420 shown in FIG. 16 has a configuration similar to that of the opposite substrate 120 shown in FIG. 3 or the opposite substrate 220 shown in FIG. 6, excluding the fact that the thickness of the optical compensation layer GP differs. Moreover, the transistor array substrate 400 also has a configuration similar to that of the transistor array substrate 300 shown in FIG. 15, excluding the fact that the thickness of the optical compensation layer GP differs.

In the example shown in FIG. 16, the optical compensation layers disposed in the opposite substrate 420 and the transistor array substrate 400 both have a similar configuration. For example, in a case where half the layer of the optical compensation layer GP described in the first embodiment is disposed in the opposite substrate 420 and approximately half the remaining layer is disposed in the transistor array substrate 400. Similarly, in a case where approximately half the layer of each of the stack groups GP1 and GP2 in the optical compensation element 323 described in the second embodiment is disposed in the opposite substrate 420, approximately half the remaining layer is disposed in the transistor array substrate 400.

Next, a modified example of the fourth embodiment will be described.

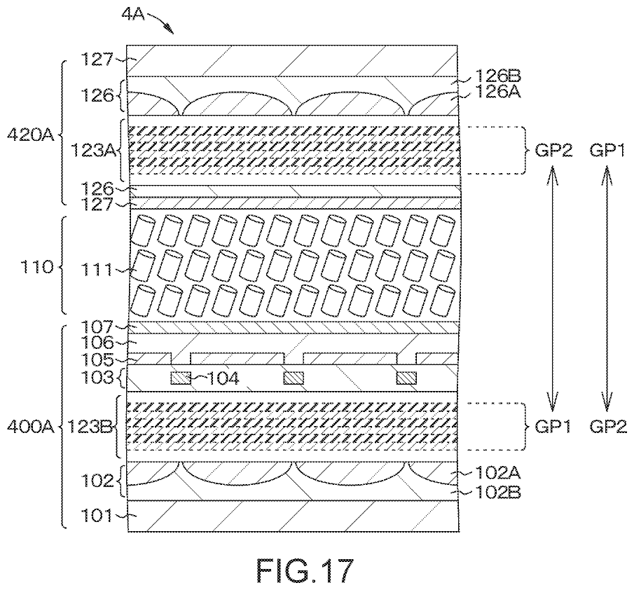

FIG. 17 is a schematic partial cross-sectional view for describing the liquid-crystal display device according to the modified example of the fourth embodiment.

Also in a liquid-crystal display device 4A according to the modified example, optical compensation layers are provided in an opposite substrate 420A and a transistor array substrate 400A. It should be noted that a first stack group in which high-refractive-index obliquely deposited films and low-refractive-index obliquely deposited films are alternately deposited is provided in the opposite substrate 420A, the high-refractive-index obliquely deposited films and the low-refractive-index obliquely deposited films having a first tilt direction with respect to a normal line of the surface on which the films are deposited. In addition, a second stack group in which high-refractive-index obliquely deposited films and low-refractive-index obliquely deposited films are alternately deposited is provided in the transistor array substrate 400A, the high-refractive-index obliquely deposited films and the low-refractive-index obliquely deposited films having a second tilt direction different from the first tilt direction.

For example, in a case where the optical compensation element 123A provided in the opposite substrate 420A has a configuration similar to that of the stack group GP1 described in the second embodiment, an optical compensation element 123B provided in the transistor array substrate 400A is disposed with a configuration similar to that of the stack group GP2 described in the second embodiment. On the contrary, in a case where the optical compensation element 123A provided in the opposite substrate 420A has a configuration similar to that of the stack group GP2 described in the second embodiment, the optical compensation element 123B provided in the transistor array substrate 400A is disposed with a configuration similar to that of the stack group GP1 described in the second embodiment.

### Fifth Embodiment

A fifth embodiment also pertains to an optical compensation element, a liquid-crystal display device, and an electronic apparatus according to the present disclosure.

In the first embodiment to the fifth embodiment, the optical compensation layer(s) is disposed in the liquid-crystal display device. In contrast, in the fifth embodiment, the optical compensation element having the optical compensation layer is, as another member, attached outside the opposite substrate, which is a different point.

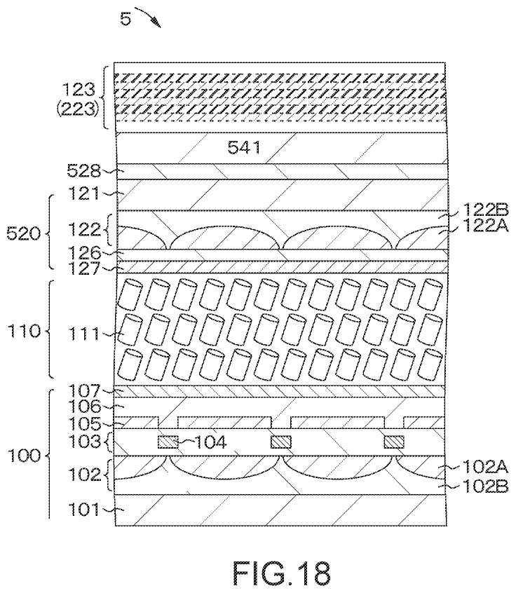

FIG. 18 is a schematic partial cross-sectional view for describing the liquid-crystal display device according to the fifth embodiment. In the schematic diagram of the liquid-crystal display device according to the fifth embodiment, it is sufficient that the liquid-crystal display device 1 in FIG. 1 is replaced by a liquid-crystal display device 5. Moreover, in the schematic cross-sectional view for describing a basic configuration of the liquid-crystal display device, it is sufficient that the liquid-crystal display device 1 in FIG. 2A is replaced by the liquid-crystal display device 5 and the opposite substrate 120 is replaced by an opposite substrate 520.

The opposite substrate 520 shown in FIG. 18 has a configuration obtained by removing the optical compensation element 123 from the opposite substrate 120 shown in FIG. 3. In addition, the optical compensation element 123 or the optical compensation element 223 formed on a transparent substrate 541 is fixed with an adhesion resin 528.

As the definition increases, the pixel pitch decreases. Therefore, disposing an optical compensation element between the micro-lenses extends the optical path length. Accordingly, oblique light components on the emitter side increases, which becomes a factor that lowers the contrast. Disposing the optical compensation element outside the micro-lenses can shorten the optical path length, and therefore the contrast can be prevented from lowering.

### Sixth Embodiment

A sixth embodiment pertains to the optical compensation element according to the present disclosure.

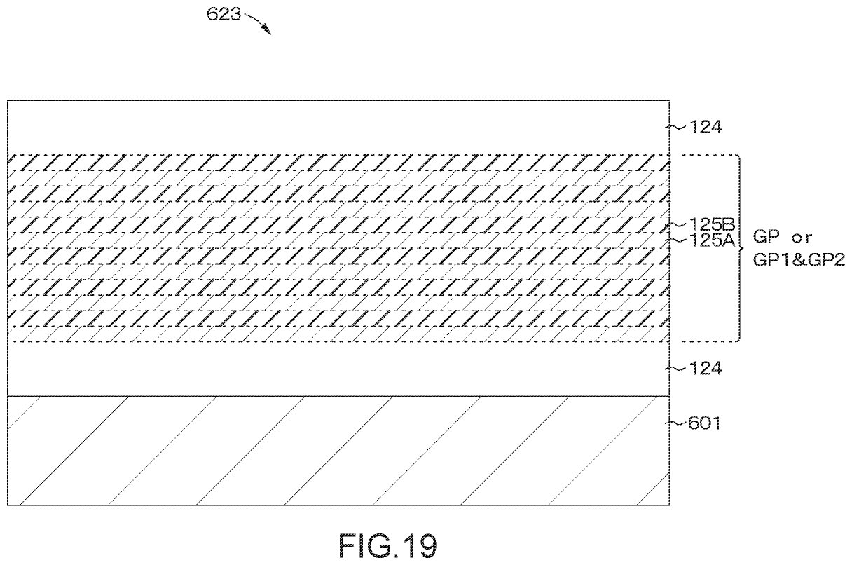

FIG. 19 is a schematic partial cross-sectional view for describing the optical compensation element according to the sixth embodiment.

An optical compensation element 623 includes a substrate 601 and an optical compensation layer formed on the substrate. The configuration of the optical compensation layer is similar to the configuration described in the first embodiment or the second embodiment.

The substrate 601 is constituted by a quartz substrate, for example. A base layer 124 on the side of the substrate 601 functions as an inter-layer film and the film thickness can be varied in accordance with the design of the optical path length of the optical compensation element. It should be noted that as in FIG. 11, anti-reflection layers may be disposed above and below the optical compensation layer.

The optical compensation element 623 is configured so that the optical properties are tilted without tilting the optical compensation element 623 itself. That is, the optical compensation element 623 exhibits properties obtained by adding the properties of the O-plate to the properties of the C-plate. The optical compensation element 623 can be used as an external optical compensation element or as an optical compensation element in the opposite substrate.

Next, various modified examples will be described.

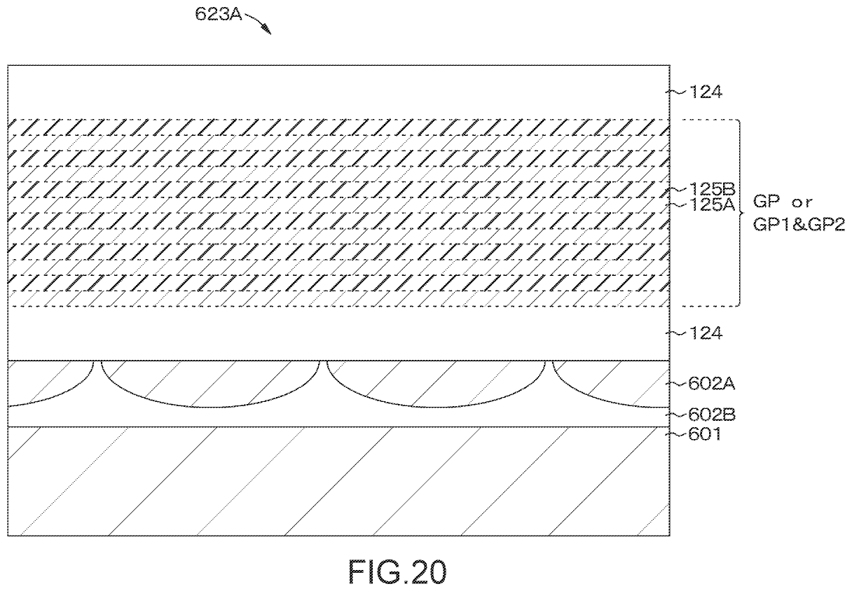

FIG. 20 is a schematic partial cross-sectional view for describing an optical compensation element according to a first modified example of the sixth embodiment.

An optical compensation element 623A has a configuration obtained by adding micro-lenses to the optical compensation element 623. Micro-lenses 602A are formed on the substrate 601. The reference sign 602B denotes a filler layer. It should be noted that the micro-lenses may be in the quartz substrate or may be formed in the inter-layer film. The optical compensation element 623A can be used as the optical compensation element in the opposite substrate.

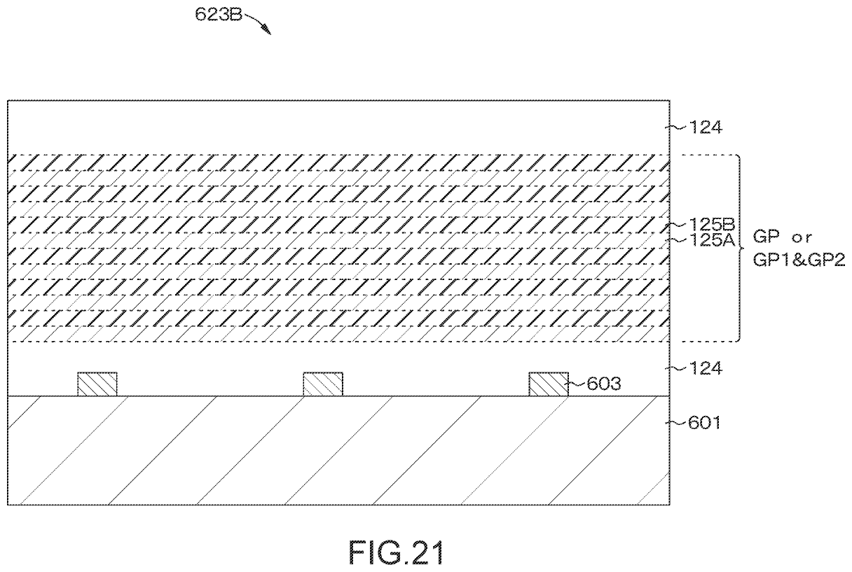

FIG. 21 is a schematic partial cross-sectional view for describing an optical compensation element according to a second modified example of the sixth embodiment.

An optical compensation element 623B has a configuration obtained by adding a black matrix to the optical compensation element 623. A black matrix 603 is formed in the substrate 601. The black matrix 603 can be formed by, for example, patterning a metal material layer in a grid form. The optical compensation element 623B can be used as the optical compensation element in the opposite substrate.

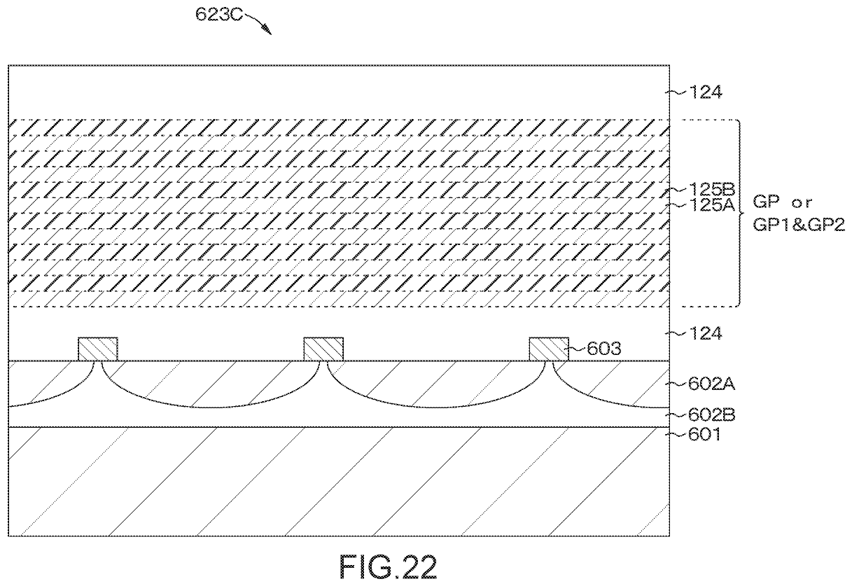

FIG. 22 is a schematic partial cross-sectional view for describing an optical compensation element according to a third modified example of the sixth embodiment.

The optical compensation element 623A has a configuration obtained by adding a black matrix and micro-lenses to the optical compensation element 623. Micro-lenses 602A are formed in the substrate 601. The reference sign 602B denotes a filler layer. It should be noted that the micro-lenses may be formed in the quartz substrate or may be formed in the inter-layer film. The black matrix 603 can be formed by, for example, patterning a metal material layer in a grid form. An optical compensation element 623C can be used as the optical compensation element in the opposite substrate.

As described above referring to the various embodiments, the types of optical compensation elements can be reduced in the liquid-crystal display device of the present disclosure. Moreover, the optical compensation element of the present disclosure has a configuration favorable for forming the substrate to be used in the liquid-crystal display device.

[Description of Electronic Apparatus]

The liquid-crystal display device according to the present disclosure described above can be used as a display unit (display device) of an electronic apparatus in any field for displaying video signals input to the electronic apparatus or video signals generated in the electronic apparatus as an image or video. For example, the liquid-crystal display device can be used as a display unit in a television set, a digital still camera, a laptop personal computer, a mobile terminal device such as a mobile telephone, a video camera, a head-mounted display (display attached on one's head), and so on.

The liquid-crystal display device of the present disclosure may even include a module-shaped device in a sealed configuration. An example may be a display module formed by attaching opposite units including a transparent glass material or the like to the pixel array unit. It should be noted that the display module may be provided with a circuit unit, a flexible printed circuit (FPC), and the like for inputting and outputting signals and the like from the outside to the pixel array unit. As specific examples of an electronic apparatus using the liquid-crystal display device of the present disclosure, a projection-type display device, a digital still camera, and a head-mounted display are shown below. It should be noted that, however, the specific examples illustrated here are merely exemplary and not limitative.

### SPECIFIC EXAMPLE 1

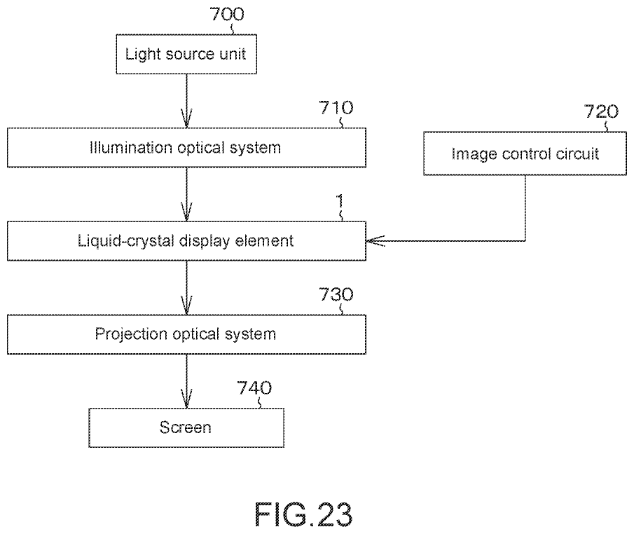

FIG. 23 is a conceptual diagram of the projection-type display device using the liquid-crystal display device of the present disclosure. The projection-type display device includes a light source unit 700, an illumination optical system 710, the liquid-crystal display device 1, an image control circuit 720 that drives the liquid-crystal display device, a projection optical system 730, a screen 740, and the like. The light source unit 700 can be constituted by, for example, a various lamp such as a xenon lamp and a semiconductor light-emitting element such as a light-emitting diode. The illumination optical system 710 is used for guiding light from the light source unit 700 to the liquid-crystal display device 1 and is constituted by an optical element such as a prism and a dichroic mirror. The liquid-crystal display device 1 acts as a light bulb and an image is projected onto the screen 740 via the projection optical system 730.

### SPECIFIC EXAMPLE 2

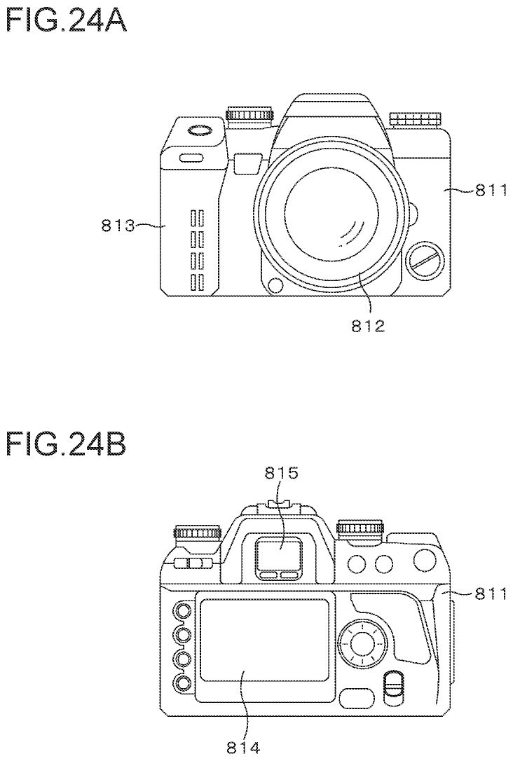

FIG. 24 is an external view of a lens-interchangeable single-lens reflex type digital still camera in which FIG. 24A shows a front view thereof and FIG. 24B shows a rear view thereof. The lens-interchangeable single-lens reflex type digital still camera includes, for example, an interchangeable photographing lens unit (interchangeable lens) 812 on the front right side of a camera main body (camera body) 811 and a grip portion 813 to be gripped by a photographer on the front left side.

In addition, a monitor 814 is disposed substantially in the center of the rear surface of the camera main body 811. A viewfinder (eyepiece window) 815 is disposed above the monitor 814. By looking through the viewfinder 815, the photographer can visually recognize the optical image of the subject guided from the photographing lens unit 812 to determine the composition.

In the lens-interchangeable single-lens reflex type digital still camera as configured above, the liquid-crystal display device of the present disclosure can be used as the viewfinder 815. That is, the lens-interchangeable single-lens reflex type digital still camera according to this example is produced by using the liquid-crystal display device of the present disclosure as the viewfinder 815.

### SPECIFIC EXAMPLE 3

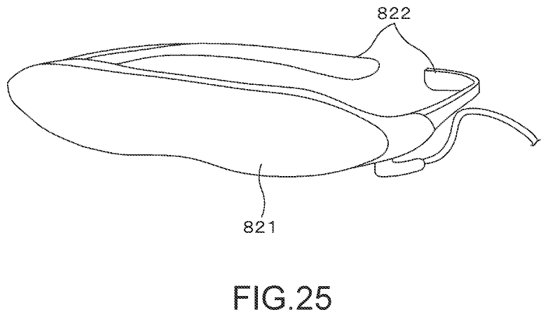

FIG. 25 is an external view of a head-mounted display. The head-mounted display includes, for example, an ear hook portion 822 on both sides of an eyeglass-shaped display portion 821 so that the head-mounted display is attached on the user's head. In the head-mounted display, the liquid-crystal display device of the present disclosure can be used as the display portion 821. That is, the head-mounted display according to this example is produced by using the liquid-crystal display device of the present disclosure as the display portion 821.

### SPECIFIC EXAMPLE 4

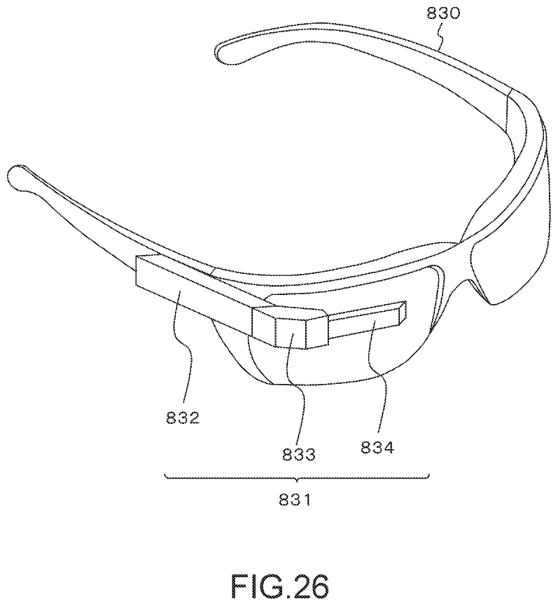

FIG. 26 is an external view of a see-through head-mounted display. The see-through head-mounted display 831 includes a main body 832, an arm 833, and a lens barrel 834.

The main body 832 is connected to the arm 833 and to eyeglasses 600. Specifically, an end of the main body 832 with respect to the long side direction is connected to the arm 833, and one of the side surfaces of the main body 832 is connected to the eyeglasses 600 via a connection member. It should be noted that the main body 832 may be directly attached on the head of a human body.

The main body 832 includes a control board for controlling operations of the see-through head-mounted display 831 and also includes a display unit. The arm 833 connects the main body 832 and the lens barrel 834 and supports the lens barrel 834. Specifically, the arm 833 is coupled to an end of the main body 832 and to an end of the lens barrel 834 to fix the lens barrel 834. Moreover, the arm 833 includes a signal line for exchanging data regarding an image provided by the main body 832 to the lens barrel 834.

The lens barrel 834 projects, through an eyepiece, image light provided by the main body 832 via the arm 833 onto the eyes of the user wearing the see-through head-mounted display 831. In the see-through head-mounted display 831, the liquid-crystal display device of the present disclosure can be used as the display unit in the main body 832.

### APPLICATION EXAMPLES

The technology according to the present disclosure is applicable to various products. For example, the technology according to the present disclosure may be realized as an apparatus mounted in any type of mobile objects including an automobile, an electric vehicle, a hybrid electric vehicle, a motorcycle, a bicycle, a personal mobility, an airplane, a drone, a ship, a robot, a construction machine, an agricultural machine (tractor), and the like.

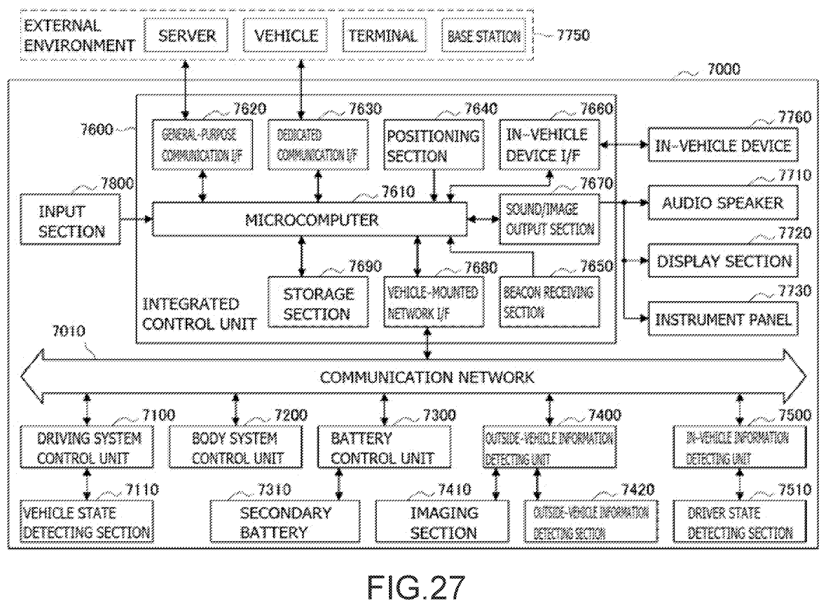

FIG. 27 is a block diagram depicting an example of schematic configuration of a vehicle control system 7000 as an example of a mobile body control system to which the technology according to an embodiment of the present disclosure can be applied. The vehicle control system 7000 includes a plurality of electronic control units connected to each other via a communication network 7010. In the example depicted in FIG. 27, the vehicle control system 7000 includes a driving system control unit 7100, a body system control unit 7200, a battery control unit 7300, an outside-vehicle information detecting unit 7400, an in-vehicle information detecting unit 7500, and an integrated control unit 7600. The communication network 7010 connecting the plurality of control units to each other may, for example, be a vehicle-mounted communication network compliant with an arbitrary standard such as controller area network (CAN), local interconnect network (LIN), local area network (LAN), FlexRay (registered trademark), or the like.

Each of the control units includes: a microcomputer that performs arithmetic processing according to various kinds of programs; a storage section that stores the programs executed by the microcomputer, parameters used for various kinds of operations, or the like; and a driving circuit that drives various kinds of control target devices. Each of the control units further includes: a network interface (I/F) for performing communication with other control units via the communication network 7010; and a communication I/F for performing communication with a device, a sensor, or the like within and without the vehicle by wire communication or radio communication. A functional configuration of the integrated control unit 7600 illustrated in FIG. 27 includes a microcomputer 7610, a general-purpose communication I/F 7620, a dedicated communication I/F 7630, a positioning section 7640, a beacon receiving section 7650, an in-vehicle device I/F 7660, a sound/image output section 7670, a vehicle-mounted network I/F 7680, and a storage section 7690. The other control units similarly include a microcomputer, a communication I/F, a storage section, and the like.

The driving system control unit 7100 controls the operation of devices related to the driving system of the vehicle in accordance with various kinds of programs. For example, the driving system control unit 7100 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like. The driving system control unit 7100 may have a function as a control device of an antilock brake system (ABS), electronic stability control (ESC), or the like.

The driving system control unit 7100 is connected with a vehicle state detecting section 7110. The vehicle state detecting section 7110, for example, includes at least one of a gyro sensor that detects the angular velocity of axial rotational movement of a vehicle body, an acceleration sensor that detects the acceleration of the vehicle, and sensors for detecting an amount of operation of an accelerator pedal, an amount of operation of a brake pedal, the steering angle of a steering wheel, an engine speed or the rotational speed of wheels, and the like. The driving system control unit 7100 performs arithmetic processing using a signal input from the vehicle state detecting section 7110, and controls the internal combustion engine, the driving motor, an electric power steering device, the brake device, and the like.

The body system control unit 7200 controls the operation of various kinds of devices provided to the vehicle body in accordance with various kinds of programs. For example, the body system control unit 7200 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 7200. The body system control unit 7200 receives these input radio waves or signals, and controls a door lock device, the power window device, the lamps, or the like of the vehicle.

The battery control unit 7300 controls a secondary battery 7310, which is a power supply source for the driving motor, in accordance with various kinds of programs. For example, the battery control unit 7300 is supplied with information about a battery temperature, a battery output voltage, an amount of charge remaining in the battery, or the like from a battery device including the secondary battery 7310. The battery control unit 7300 performs arithmetic processing using these signals, and performs control for regulating the temperature of the secondary battery 7310 or controls a cooling device provided to the battery device or the like.

The outside-vehicle information detecting unit 7400 detects information about the outside of the vehicle including the vehicle control system 7000. For example, the outside-vehicle information detecting unit 7400 is connected with at least one of an imaging section 7410 and an outside-vehicle information detecting section 7420. The imaging section 7410 includes at least one of a time-of-flight (ToF) camera, a stereo camera, a monocular camera, an infrared camera, and other cameras. The outside-vehicle information detecting section 7420, for example, includes at least one of an environmental sensor for detecting current atmospheric conditions or weather conditions and a peripheral information detecting sensor for detecting another vehicle, an obstacle, a pedestrian, or the like on the periphery of the vehicle including the vehicle control system 7000.

The environmental sensor, for example, may be at least one of a rain drop sensor detecting rain, a fog sensor detecting a fog, a sunshine sensor detecting a degree of sunshine, and a snow sensor detecting a snowfall. The peripheral information detecting sensor may be at least one of an ultrasonic sensor, a radar device, and a LIDAR device (Light detection and Ranging device, or Laser imaging detection and ranging device). Each of the imaging section 7410 and the outside-vehicle information detecting section 7420 may be provided as an independent sensor or device, or may be provided as a device in which a plurality of sensors or devices are integrated.

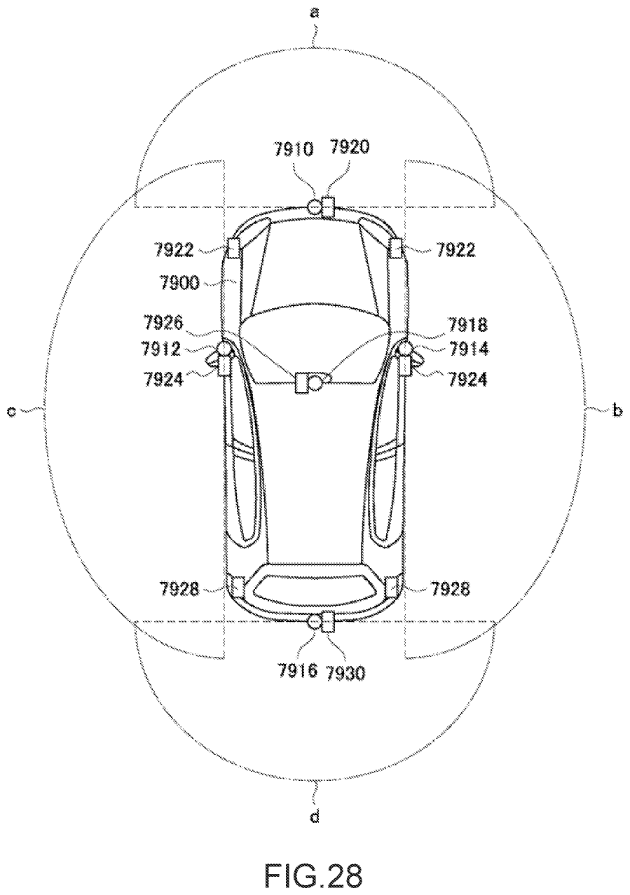

FIG. 28 depicts an example of installation positions of the imaging section 7410 and the outside-vehicle information detecting section 7420. Imaging sections 7910, 7912, 7914, 7916, and 7918 are, for example, disposed at at least one of positions on a front nose, sideview mirrors, a rear bumper, and a back door of the vehicle 7900 and a position on an upper portion of a windshield within the interior of the vehicle. The imaging section 7910 provided to the front nose and the imaging section 7918 provided to the upper portion of the windshield within the interior of the vehicle obtain mainly an image of the front of the vehicle 7900. The imaging sections 7912 and 7914 provided to the sideview mirrors obtain mainly an image of the sides of the vehicle 7900. The imaging section 7916 provided to the rear bumper or the back door obtains mainly an image of the rear of the vehicle 7900. The imaging section 7918 provided to the upper portion of the windshield within the interior of the vehicle is used mainly to detect a preceding vehicle, a pedestrian, an obstacle, a signal, a traffic sign, a lane, or the like.

Incidentally, FIG. 28 depicts an example of photographing ranges of the respective imaging sections 7910, 7912, 7914, and 7916. An imaging range a represents the imaging range of the imaging section 7910 provided to the front nose. Imaging ranges b and c respectively represent the imaging ranges of the imaging sections 7912 and 7914 provided to the sideview mirrors. An imaging range d represents the imaging range of the imaging section 7916 provided to the rear bumper or the back door. A bird's-eye image of the vehicle 7900 as viewed from above can be obtained by superimposing image data imaged by the imaging sections 7910, 7912, 7914, and 7916, for example.

Outside-vehicle information detecting sections 7920, 7922, 7924, 7926, 7928, and 7930 provided to the front, rear, sides, and corners of the vehicle 7900 and the upper portion of the windshield within the interior of the vehicle may be, for example, an ultrasonic sensor or a radar device. The outside-vehicle information detecting sections 7920, 7926, and 7930 provided to the front nose of the vehicle 7900, the rear bumper, the back door of the vehicle 7900, and the upper portion of the windshield within the interior of the vehicle may be a LIDAR device, for example. These outside-vehicle information detecting sections 7920 to 7930 are used mainly to detect a preceding vehicle, a pedestrian, an obstacle, or the like.

Returning to FIG. 27, the description will be continued. The outside-vehicle information detecting unit 7400 makes the imaging section 7410 image an image of the outside of the vehicle, and receives imaged image data. In addition, the outside-vehicle information detecting unit 7400 receives detection information from the outside-vehicle information detecting section 7420 connected to the outside-vehicle information detecting unit 7400. In a case where the outside-vehicle information detecting section 7420 is an ultrasonic sensor, a radar device, or a LIDAR device, the outside-vehicle information detecting unit 7400 transmits an ultrasonic wave, an electromagnetic wave, or the like, and receives information of a received reflected wave. On the basis of the received information, the outside-vehicle information detecting unit 7400 may perform processing of detecting an object such as a human, a vehicle, an obstacle, a sign, a character on a road surface, or the like, or processing of detecting a distance thereto. The outside-vehicle information detecting unit 7400 may perform environment recognition processing of recognizing a rainfall, a fog, road surface conditions, or the like on the basis of the received information. The outside-vehicle information detecting unit 7400 may calculate a distance to an object outside the vehicle on the basis of the received information.

In addition, on the basis of the received image data, the outside-vehicle information detecting unit 7400 may perform image recognition processing of recognizing a human, a vehicle, an obstacle, a sign, a character on a road surface, or the like, or processing of detecting a distance thereto. The outside-vehicle information detecting unit 7400 may subject the received image data to processing such as distortion correction, alignment, or the like, and combine the image data imaged by a plurality of different imaging sections 7410 to generate a bird's-eye image or a panoramic image. The outside-vehicle information detecting unit 7400 may perform viewpoint conversion processing using the image data imaged by the imaging section 7410 including the different imaging parts.

The in-vehicle information detecting unit 7500 detects information about the inside of the vehicle. The in-vehicle information detecting unit 7500 is, for example, connected with a driver state detecting section 7510 that detects the state of a driver. The driver state detecting section 7510 may include a camera that images the driver, a biosensor that detects biological information of the driver, a microphone that collects sound within the interior of the vehicle, or the like. The biosensor is, for example, disposed in a seat surface, the steering wheel, or the like, and detects biological information of an occupant sitting in a seat or the driver holding the steering wheel. On the basis of detection information input from the driver state detecting section 7510, the in-vehicle information detecting unit 7500 may calculate a degree of fatigue of the driver or a degree of concentration of the driver, or may determine whether the driver is dozing. The in-vehicle information detecting unit 7500 may subject an audio signal obtained by the collection of the sound to processing such as noise canceling processing or the like.

The integrated control unit 7600 controls general operation within the vehicle control system 7000 in accordance with various kinds of programs. The integrated control unit 7600 is connected with an input section 7800. The input section 7800 is implemented by a device capable of input operation by an occupant, such, for example, as a touch panel, a button, a microphone, a switch, a lever, or the like. The integrated control unit 7600 may be supplied with data obtained by voice recognition of voice input through the microphone. The input section 7800 may, for example, be a remote control device using infrared rays or other radio waves, or an external connecting device such as a mobile telephone, a personal digital assistant (PDA), or the like that supports operation of the vehicle control system 7000. The input section 7800 may be, for example, a camera. In that case, an occupant can input information by gesture. Alternatively, data may be input which is obtained by detecting the movement of a wearable device that an occupant wears. Further, the input section 7800 may, for example, include an input control circuit or the like that generates an input signal on the basis of information input by an occupant or the like using the above-described input section 7800, and which outputs the generated input signal to the integrated control unit 7600. An occupant or the like inputs various kinds of data or gives an instruction for processing operation to the vehicle control system 7000 by operating the input section 7800.

The storage section 7690 may include a read only memory (ROM) that stores various kinds of programs executed by the microcomputer and a random access memory (RAM) that stores various kinds of parameters, operation results, sensor values, or the like. In addition, the storage section 7690 may be implemented by a magnetic storage device such as a hard disc drive (HDD) or the like, a semiconductor storage device, an optical storage device, a magneto-optical storage device, or the like.

The general-purpose communication I/F 7620 is a communication I/F used widely, which communication I/F mediates communication with various apparatuses present in an external environment 7750. The general-purpose communication I/F 7620 may implement a cellular communication protocol such as global system for mobile communications (GSM (registered trademark)), worldwide interoperability for microwave access (WiMAX (registered trademark)), long term evolution (LTE (registered trademark)), LTE-advanced (LTE-A), or the like, or another wireless communication protocol such as wireless LAN (referred to also as wireless fidelity (Wi-Fi (registered trademark)), Bluetooth (registered trademark), or the like. The general-purpose communication I/F 7620 may, for example, connect to an apparatus (for example, an application server or a control server) present on an external network (for example, the Internet, a cloud network, or a company-specific network) via a base station or an access point. In addition, the general-purpose communication I/F 7620 may connect to a terminal present in the vicinity of the vehicle (which terminal is, for example, a terminal of the driver, a pedestrian, or a store, or a machine type communication (MTC) terminal) using a peer to peer (P2P) technology, for example.

The dedicated communication I/F 7630 is a communication I/F that supports a communication protocol developed for use in vehicles. The dedicated communication I/F 7630 may implement a standard protocol such, for example, as wireless access in vehicle environment (WAVE), which is a combination of institute of electrical and electronic engineers (IEEE) 802.11p as a lower layer and IEEE 1609 as a higher layer, dedicated short range communications (DSRC), or a cellular communication protocol. The dedicated communication I/F 7630 typically carries out V2X communication as a concept including one or more of communication between a vehicle and a vehicle (Vehicle to Vehicle), communication between a road and a vehicle (Vehicle to Infrastructure), communication between a vehicle and a home (Vehicle to Home), and communication between a pedestrian and a vehicle (Vehicle to Pedestrian).

The positioning section 7640, for example, performs positioning by receiving a global navigation satellite system (GNSS) signal from a GNSS satellite (for example, a GPS signal from a global positioning system (GPS) satellite), and generates positional information including the latitude, longitude, and altitude of the vehicle. Incidentally, the positioning section 7640 may identify a current position by exchanging signals with a wireless access point, or may obtain the positional information from a terminal such as a mobile telephone, a personal handyphone system (PHS), or a smart phone that has a positioning function.

The beacon receiving section 7650, for example, receives a radio wave or an electromagnetic wave transmitted from a radio station installed on a road or the like, and thereby obtains information about the current position, congestion, a closed road, a necessary time, or the like. Incidentally, the function of the beacon receiving section 7650 may be included in the dedicated communication I/F 7630 described above.

The in-vehicle device I/F 7660 is a communication interface that mediates connection between the microcomputer 7610 and various in-vehicle devices 7760 present within the vehicle. The in-vehicle device I/F 7660 may establish wireless connection using a wireless communication protocol such as wireless LAN, Bluetooth (registered trademark), near field communication (NFC), or wireless universal serial bus (WUSB). In addition, the in-vehicle device I/F 7660 may establish wired connection by universal serial bus (USB), high-definition multimedia interface (HDMI (registered trademark)), mobile high-definition link (MHL), or the like via a connection terminal (and a cable if necessary) not depicted in the figures. The in-vehicle devices 7760 may, for example, include at least one of a mobile device and a wearable device possessed by an occupant and an information device carried into or attached to the vehicle. The in-vehicle devices 7760 may also include a navigation device that searches for a path to an arbitrary destination. The in-vehicle device I/F 7660 exchanges control signals or data signals with these in-vehicle devices 7760.

The vehicle-mounted network I/F 7680 is an interface that mediates communication between the microcomputer 7610 and the communication network 7010. The vehicle-mounted network I/F 7680 transmits and receives signals or the like in conformity with a predetermined protocol supported by the communication network 7010.

The microcomputer 7610 of the integrated control unit 7600 controls the vehicle control system 7000 in accordance with various kinds of programs on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. For example, the microcomputer 7610 may calculate a control target value for the driving force generating device, the steering mechanism, or the braking device on the basis of the obtained information about the inside and outside of the vehicle, and output a control command to the driving system control unit 7100. For example, the microcomputer 7610 may perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like. In addition, the microcomputer 7610 may perform cooperative control intended for automatic driving, which makes the vehicle to travel autonomously without depending on the operation of the driver, or the like, by controlling the driving force generating device, the steering mechanism, the braking device, or the like on the basis of the obtained information about the surroundings of the vehicle.

The microcomputer 7610 may generate three-dimensional distance information between the vehicle and an object such as a surrounding structure, a person, or the like, and generate local map information including information about the surroundings of the current position of the vehicle, on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. In addition, the microcomputer 7610 may predict danger such as collision of the vehicle, approaching of a pedestrian or the like, an entry to a closed road, or the like on the basis of the obtained information, and generate a warning signal. The warning signal may, for example, be a signal for producing a warning sound or lighting a warning lamp.

The sound/image output section 7670 transmits an output signal of at least one of a sound and an image to an output device capable of visually or auditorily notifying information to an occupant of the vehicle or the outside of the vehicle. In the example of FIG. 27, an audio speaker 7710, a display section 7720, and an instrument panel 7730 are illustrated as the output device. The display section 7720 may, for example, include at least one of an on-board display and a head-up display. The display section 7720 may have an augmented reality (AR) display function. The output device may be other than these devices, and may be another device such as headphones, a wearable device such as an eyeglass type display worn by an occupant or the like, a projector, a lamp, or the like. In a case where the output device is a display device, the display device visually displays results obtained by various kinds of processing performed by the microcomputer 7610 or information received from another control unit in various forms such as text, an image, a table, a graph, or the like. In addition, in a case where the output device is an audio output device, the audio output device converts an audio signal constituted of reproduced audio data or sound data or the like into an analog signal, and auditorily outputs the analog signal.

Incidentally, at least two control units connected to each other via the communication network 7010 in the example depicted in FIG. 27 may be integrated into one control unit. Alternatively, each individual control unit may include a plurality of control units. Further, the vehicle control system 7000 may include another control unit not depicted in the figures. In addition, part or the whole of the functions performed by one of the control units in the above description may be assigned to another control unit. That is, predetermined arithmetic processing may be performed by any of the control units as long as information is transmitted and received via the communication network 7010. Similarly, a sensor or a device connected to one of the control units may be connected to another control unit, and a plurality of control units may mutually transmit and receive detection information via the communication network 7010.

The technology according to the present disclosure can be applied to a display unit of an output apparatus capable notifying information in terms of the sense of vision or the sense of hearing, for example, out of the configurations described above.

[Others]

The technology of the present disclosure can also take the following configurations.
[A1] A liquid-crystal display device, including:

a pair of substrates;

a liquid-crystal material layer sandwiched between the pair of substrates; and

an optical compensation element having an optical compensation layer, in which

the optical compensation layer includes a stack group in which high-refractive-index obliquely deposited films and low-refractive-index obliquely deposited films are alternately deposited, the high-refractive-index obliquely deposited films and the low-refractive-index obliquely deposited films having a same tilt direction with respect to a normal line of a surface on which the films are deposited.
[A2] The liquid-crystal display device according to [A1], in which

the optical compensation layer includes a first stack group in which high-refractive-index obliquely deposited films and low-refractive-index obliquely deposited films are alternately deposited, the high-refractive-index obliquely deposited films and the low-refractive-index obliquely deposited films having a first tilt direction with respect to the normal line of the surface on which the films are deposited and a second stack group in which high-refractive-index obliquely deposited films and low-refractive-index obliquely deposited films are alternately deposited, the high-refractive-index obliquely deposited films and the low-refractive-index obliquely deposited films having a second tilt direction different from the first tilt direction.
[A3] The liquid-crystal display device according to [A2], in which

the first tilt direction and the second tilt direction are set so that components conforming to the surface on which the films are deposited are orthogonal.
[A4] The liquid-crystal display device according to any one of [A1] to [A3], in which

a deposition angle of the high-refractive-index obliquely deposited films and the low-refractive-index obliquely deposited films with respect to the normal line of the surface on which the films are deposited is 45 degrees or less.
[A5] The liquid-crystal display device according to any one of [A1] to [A4], further including:

as the pair of substrates, a transistor array substrate and an opposite substrate disposed to be opposite to the transistor array substrate.
[A6] The liquid-crystal display device according to [A5], in which

the optical compensation layer is provided in the opposite substrate.
[A7] The liquid-crystal display device according to [A5], in which

the optical compensation layer is provided in the transistor array substrate.
[A8] The liquid-crystal display device according to [A5], in which

the optical compensation layer is provided in the opposite substrate and the transistor array substrate.
[A9] The liquid-crystal display device according to [A8], in which

a first stack group in which the high-refractive-index obliquely deposited films and the low-refractive-index obliquely deposited films are alternately deposited is provided in the opposite substrate, the high-refractive-index obliquely deposited films and the low-refractive-index obliquely deposited films having a first tilt direction with respect to the normal line of the surface on which the films are deposited, and

a second stack group in which the high-refractive-index obliquely deposited films and the low-refractive-index obliquely deposited films are alternately deposited is provided in the transistor array substrate, the high-refractive-index obliquely deposited films and the low-refractive-index obliquely deposited films having a second tilt direction different from the first tilt direction.
[A10] The liquid-crystal display device according to [A9], in which

the first tilt direction and the second tilt direction are set so that components conforming to the surface on which the films are deposited are orthogonal.
[A11] The liquid-crystal display device according to [A5] to [A10], in which

a black matrix and/or a micro-lens is formed in the opposite substrate.
[A12] The liquid-crystal display device according to [A5] to [A11], in which

a black matrix and/or a micro-lens is formed in the transistor array substrate.
[B1] An optical compensation element, including

an optical compensation layer including a stack group in which high-refractive-index obliquely deposited films and low-refractive-index obliquely deposited films are alternately deposited, the high-refractive-index obliquely deposited films and the low-refractive-index obliquely deposited films having a same tilt direction with respect to a normal line of a surface on which the films are deposited.
[B2] The optical compensation element according to [B1], in which

the optical compensation layer includes a first stack group in which high-refractive-index obliquely deposited films and low-refractive-index obliquely deposited films are alternately deposited, the high-refractive-index obliquely deposited films and the low-refractive-index obliquely deposited films having a first tilt direction with respect to the normal line of the surface on which the films are deposited and a second stack group in which high-refractive-index obliquely deposited films and low-refractive-index obliquely deposited films are alternately deposited, the high-refractive-index obliquely deposited films and the low-refractive-index obliquely deposited films having a second tilt direction different from the first tilt direction.
[B3] The optical compensation element according to [B2], in which

the first tilt direction and the second tilt direction are set so that components conforming to the surface on which the films are deposited are orthogonal.
[B4] The optical compensation element according to any one of [B1] to [B3], in which

a deposition angle of the high-refractive-index obliquely deposited films and the low-refractive-index obliquely deposited films with respect to the normal line of the surface on which the films are deposited is 45 degrees or less.
[B5] The optical compensation element according to any one of [B1] to [B4], in which

the optical compensation element includes
a substrate and the optical compensation layer formed on the substrate.
[B6] The optical compensation element according to [B5], in which

a black matrix and/or a micro-lens is formed in the substrate.
[C1] An electronic apparatus, including

a liquid-crystal display device including
a pair of substrates,
a liquid-crystal material layer sandwiched between the pair of substrates, and
an optical compensation element having an optical compensation layer, in which

the optical compensation layer includes a stack group in which high-refractive-index obliquely deposited films and low-refractive-index obliquely deposited films are alternately deposited, the high-refractive-index obliquely deposited films and the low-refractive-index obliquely deposited films having a same tilt direction with respect to a normal line of a surface on which the films are deposited.
[C2] The electronic apparatus according to [A1], in which

the optical compensation layer includes a first stack group in which high-refractive-index obliquely deposited films and low-refractive-index obliquely deposited films are alternately deposited, the high-refractive-index obliquely deposited films and the low-refractive-index obliquely deposited films having a first tilt direction with respect to the normal line of the surface on which the films are deposited and a second stack group in which high-refractive-index obliquely deposited films and low-refractive-index obliquely deposited films are alternately deposited, the high-refractive-index obliquely deposited films and the low-refractive-index obliquely deposited films having a second tilt direction different from the first tilt direction.
[C3] The electronic apparatus according to [A2], in which

the first tilt direction and the second tilt direction are set so that components conforming to the surface on which the films are deposited are orthogonal.
[C4] The electronic apparatus according to any one of [C1] to [C3], in which

a deposition angle of the high-refractive-index obliquely deposited films and the low-refractive-index obliquely deposited films with respect to the normal line of the surface on which the films are deposited is 45 degrees or less.
[C5] The electronic apparatus according to any one of [C1] to [C4], further including:

as the pair of substrates, a transistor array substrate and an opposite substrate disposed to be opposite to the transistor array substrate.
[C6] The electronic apparatus according to [C5], in which

the optical compensation layer is provided in the opposite substrate.
[C7] The electronic apparatus according to [C5], in which

the optical compensation layer is provided in the transistor array substrate.
[C8] The electronic apparatus according to [C5], in which

the optical compensation layer is provided in the opposite substrate and the transistor array substrate.
[C9] The electronic apparatus according to [C8], in which

a first stack group in which the high-refractive-index obliquely deposited films and the low-refractive-index obliquely deposited films are alternately deposited is provided in the opposite substrate, the high-refractive-index obliquely deposited films and the low-refractive-index obliquely deposited films having a first tilt direction with respect to the normal line of the surface on which the films are deposited, and

a second stack group in which the high-refractive-index obliquely deposited films and the low-refractive-index obliquely deposited films are alternately deposited is provided in the transistor array substrate, the high-refractive-index obliquely deposited films and the low-refractive-index obliquely deposited films having a second tilt direction different from the first tilt direction.
[C10] The electronic apparatus according to [C9], in which

the first tilt direction and the second tilt direction are set so that components conforming to the surface on which the films are deposited are orthogonal.
[C11] The electronic apparatus according to [C5] to [C10], in which

a black matrix and/or a micro-lens is formed in the opposite substrate.
[C12] The electronic apparatus according to [C5] to [C11], in which

a black matrix and/or a micro-lens is formed in the transistor array substrate.

### REFERENCE SIGNS LIST

1, 2, 3, 4, 4A, 5, 9 liquid-crystal display device
11 horizontal driving circuit
12 vertical driving circuit
100 transistor array substrate
101 supporting substrate
102 micro-lens layer
102A micro-lens
102B filler layer
103 wiring layer
104 black matrix
105 pixel electrode
106 planarization film
107 alignment film
110 liquid-crystal material layer
111 liquid-crystal molecules
120 opposite substrate
121 supporting substrate
122 micro-lens layer
122A micro-lens
122B filler layer
123 optical compensation element
124 base layer
125A high-refractive-index obliquely deposited film
125B low-refractive-index obliquely deposited film
125C, 125D anti-reflection layer
126 common electrode
127 alignment film
220 opposite substrate
223 optical compensation element
300 transistor array substrate
320 opposite substrate
400, 400A transistor array substrate
420, 420A opposite substrate
520 opposite substrate
528 adhesion resin
541 transparent substrate
601 substrate
602A micro-lens
602B filler layer
603 black matrix
623, 623A, 623B, 623C optical compensation element
920 opposite substrate
923 optical compensation element
925A high-refractive index deposited film
925B low-refractive index deposited film
928 adhesion resin
940 optical compensation element
941 transparent substrate
942 optical compensation layer
GP, GP1, GP2 stack group that constitutes optical compensation layer
PX pixel
SCL scanning line
DTL signal line
TR transistor
CS capacitor structure
700 light source unit
710 illumination optical system
720 image control circuit
730 projection optical system
740 screen
811 camera main body
812 imaging lens unit
813 grip portion
814 monitor
815 viewfinder
821 eyeglass-shaped display portion
822 ear hook portion
830 eyeglasses
831 see-through head-mounted display
832 main body
833 arm
834 lens barrel

1. A liquid-crystal display device, comprising:
a pair of substrates;
a liquid-crystal material layer sandwiched between the pair of substrates; and
an optical compensation element having an optical compensation layer, wherein
the optical compensation layer includes a stack group in which high-refractive-index obliquely deposited films and low-refractive-index obliquely deposited films are alternately deposited, the high-refractive-index obliquely deposited films and the low-refractive-index obliquely deposited films having a same tilt direction with respect to a normal line of a surface on which the films are deposited.

2. The liquid-crystal display device according to claim 1, wherein
the optical compensation layer includes a first stack group in which high-refractive-index obliquely deposited films and low-refractive-index obliquely deposited films are alternately deposited, the high-refractive-index obliquely deposited films and the low-refractive-index obliquely deposited films having a first tilt direction with respect to the normal line of the surface on which the films are deposited and a second stack group in which high-refractive-index obliquely deposited films and low-refractive-index obliquely deposited films are alternately deposited, the high-refractive-index obliquely deposited films and the low-refractive-index obliquely deposited films having a second tilt direction different from the first tilt direction.

3. The liquid-crystal display device according to claim 2, wherein
the first tilt direction and the second tilt direction are set so that components conforming to the surface on which the films are deposited are orthogonal.

4. The liquid-crystal display device according to claim 1, wherein
a deposition angle of the high-refractive-index obliquely deposited films and the low-refractive-index obliquely deposited films with respect to the normal line of the surface on which the films are deposited is 45 degrees or less.

5. The liquid-crystal display device according to claim 1, further comprising:
as the pair of substrates, a transistor array substrate and an opposite substrate disposed to be opposite to the transistor array substrate.

6. The liquid-crystal display device according to claim 5, wherein
the optical compensation layer is provided in the opposite substrate.

7. The liquid-crystal display device according to claim 5, wherein
the optical compensation layer is provided in the transistor array substrate.

8. The liquid-crystal display device according to claim 5, wherein
the optical compensation layer is provided in the opposite substrate and the transistor array substrate.

9. The liquid-crystal display device according to claim 8, wherein
a first stack group in which the high-refractive-index obliquely deposited films and the low-refractive-index obliquely deposited films are alternately deposited is provided in the opposite substrate, the high-refractive-index obliquely deposited films and the low-refractive-index obliquely deposited films having a first tilt direction with respect to the normal line of the surface on which the films are deposited, and
a second stack group in which the high-refractive-index obliquely deposited films and the low-refractive-index obliquely deposited films are alternately deposited is provided in the transistor array substrate, the high-refractive-index obliquely deposited films and the low-refractive-index obliquely deposited films having a second tilt direction different from the first tilt direction.

10. The liquid-crystal display device according to claim 9, wherein
the first tilt direction and the second tilt direction are set so that components conforming to the surface on which the films are deposited are orthogonal.

11. The liquid-crystal display device according to claim 5, wherein
a black matrix and/or a micro-lens is formed in the opposite substrate.

12. The liquid-crystal display device according to claim 5, wherein
a black matrix and/or a micro-lens is formed in the transistor array substrate.

13. An optical compensation element, comprising
an optical compensation layer including a stack group in which high-refractive-index obliquely deposited films and low-refractive-index obliquely deposited films are alternately deposited, the high-refractive-index obliquely deposited films and the low-refractive-index obliquely deposited films having a same tilt direction with respect to a normal line of a surface on which the films are deposited.

14. The optical compensation element according to claim 13, wherein
the optical compensation layer includes a first stack group in which high-refractive-index obliquely deposited films and low-refractive-index obliquely deposited films are alternately deposited, the high-refractive-index obliquely deposited films and the low-refractive-index obliquely deposited films having a first tilt direction with respect to the normal line of the surface on which the films are deposited and a second stack group in which high-refractive-index obliquely deposited films and low-refractive-index obliquely deposited films are alternately deposited, the high-refractive-index obliquely deposited films and the low-refractive-index obliquely deposited films having a second tilt direction different from the first tilt direction.

15. The optical compensation element according to claim 14, wherein
the first tilt direction and the second tilt direction are set so that components conforming to the surface on which the films are deposited are orthogonal.

16. The optical compensation element according to claim 13, wherein
a deposition angle of the high-refractive-index obliquely deposited films and the low-refractive-index obliquely deposited films with respect to the normal line of the surface on which the films are deposited is 45 degrees or less.

17. The optical compensation element according to claim 13, wherein
the optical compensation element includes
a substrate and the optical compensation layer formed on the substrate.

18. The optical compensation element according to claim 17, wherein
a black matrix and/or a micro-lens is formed in the substrate.

19. An electronic apparatus, comprising
a liquid-crystal display device including
a pair of substrates,
a liquid-crystal material layer sandwiched between the pair of substrates, and
an optical compensation element having an optical compensation layer, wherein
the optical compensation layer includes a stack group in which high-refractive-index obliquely deposited films and low-refractive-index obliquely deposited films are alternately deposited, the high-refractive-index obliquely deposited films and the low-refractive-index obliquely deposited films having a same tilt direction with respect to a normal line of a surface on which the films are deposited.
